(19) United States
(12) Patent Application Publication
(10) Pub. No.: US 2023/0319849 A1
(43) Pub. Date: Oct. 5, 2023

(54) SIGNALING FOR LTE/NR SL CO-EXISTENCE

(71) Applicant: Samsung Electronics Co., Ltd., Suwon-si (KR)

(72) Inventor: Emad N. Farag, Flanders, NJ (US)

(21) Appl. No.: 18/185,348

(22) Filed: Mar. 16, 2023

Related U.S. Application Data
(60) Provisional application No. 63/325,009, filed on Mar. 29, 2022.
(60) Provisional application No. 63/325,026, filed on Mar. 29, 2022.
(60) Provisional application No. 63/336,755, filed on Apr. 29, 2022.
(60) Provisional application No. 63/336,775, filed on Apr. 29, 2022.

(51) Int. Cl. H04W 72/25; H04W 72/02; H04W 72/563; H04W 28/26

(52) U.S. Cl. CPC H04W 72/25; H04W 72/02; H04W 72/563; H04W 28/26

(57) ABSTRACT

Methods and apparatuses for signaling for a long term evolution/new radio (LTE/NR) sidelink (SL) co-existence in a wireless communication system. A method of operating a user equipment (UE) includes performing, via a LTE SL entity, sensing over a LTE SL interface including to decode SL control information (SCI) and measure a SL reference signal receive power (SL-RSRP) and selecting resources for a LTE SL transmission by the LTE SL entity. The method further includes identifying, for a NR SL entity, information related to the sensing and the selected resources and performing, for the NR SL entity, a NR SL resource selection or reselection based on the information related to the sensing and the selected resources.

### CROSS-REFERENCE TO RELATED APPLICATIONS AND CLAIM OF PRIORITY

The present application claims priority to:
U.S. Provisional Patent Application No. 63/325,009, filed on Mar. 29, 2022;
U.S. Provisional Patent Application No. 63/325,026, filed on Mar. 29, 2022;
U.S. Provisional Patent Application No. 63/336,755, filed on Apr. 29, 2022; and
U.S. Provisional Patent Application No. 63/336,775, filed on Apr. 29, 2022. The contents of the above-identified patent document is incorporated herein by reference.

### TECHNICAL FIELD

The present disclosure relates generally to wireless communication systems and, more specifically, the present disclosure relates to signaling for a long term evolution/new radio (LTE/NR) sidelink (SL) co-existence in a wireless communication system.

### BACKGROUND

5th generation (5G) or NR mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to signaling for an LTE/NR SL co-existence in a wireless communication system.

In one embodiment, a method of operating a user equipment (UE) is provided. The method includes performing, via a LTE SL entity, sensing over a LTE SL interface including to decode SCI and measure a SL reference signal receive power (SL-RSRP) and selecting resources for a LTE SL transmission by the LTE SL entity. The method further includes identifying, for a NR SL entity, information related to the sensing and the selected resources and performing, for the NR SL entity, a NR SL resource selection or reselection based on the information related to the sensing and the selected resources.

In another embodiment, a method of operating a UE is provided. The method includes performing, via a LTE SL entity, sensing over a LTE SL interface including to decode SCI and measure a SL-RSRP and selecting resources for a LTE SL transmission by the LTE SL entity. The method further includes identifying, for a NR SL entity, information related to the sensing and the selected resources and performing, for the NR SL entity, a NR SL resource selection or reselection based on the information related to the sensing and the selected resources.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The term “module” means any device, system, or part thereof that controls at least one operation. Such a module may be implemented in hardware or a combination of hardware and software and/or firmware. The functionality associated with any particular module may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to the present disclosure;

FIG. 6 illustrates an example of LTE SL resources and NR SL resources according to embodiments of the present disclosure;

FIG. 7 illustrates an example of NR and LTE SL resources according to embodiments of the present disclosure;

FIGS. 8A-8F illustrate an example of LTE SL resources, NR SL resources, and LTE and NR SL resources in a slot according to embodiments of the present disclosure;

FIG. 9 illustrates an example of UE modules according to embodiments of the present disclosure;

FIG. 10 illustrates a flowchart of a method for receiving reserved resources according to embodiments of the present disclosure;

FIG. 11 illustrates another flowchart of a method for receiving reserved resources according to embodiments of the present disclosure;

FIG. 12 illustrates a flowchart of a method for receiving an inter-UE co-ordination request according to embodiments of the present disclosure;

FIG. 13 illustrates a flowchart of a method for receiving an inter-UE co-ordination request according to embodiments of the present disclosure;

FIG. 14 illustrates a flowchart of a method for sending an inter-UE co-ordination information according to embodiments of the present disclosure;

FIG. 15 illustrates another flowchart of a method for sending an inter-UE co-ordination information according to embodiments of the present disclosure;

FIG. 16 illustrates yet another flowchart of a method for sending an inter-UE co-ordination information according to embodiments of the present disclosure;

FIG. 17 illustrates an examples of LTE SL module to send sensing results according to embodiments of the present disclosure;

FIG. 18 illustrates another example of LTE SL module to send sensing results according to embodiments of the present disclosure;

FIG. 19 illustrates yet other examples of LTE SL module to send sensing results according to embodiments of the present disclosure;

FIG. 20 illustrates yet other examples of LTE SL module to send sensing results according to embodiments of the present disclosure;

FIG. 21 illustrates yet other examples of LTE SL module to send sensing results according to embodiments of the present disclosure;

FIG. 22 illustrates a flowchart of a method for receiving reserved resources according to embodiments of the present disclosure;

FIG. 23 illustrates another flowchart of a method for receiving reserved resources according to embodiments of the present disclosure;

FIG. 24 illustrates a flowchart of a method for receiving an inter-UE co-ordination request according to embodiments of the present disclosure;

FIG. 25 illustrates a flowchart of a method for receiving an inter-UE co-ordination request according to embodiments of the present disclosure;

FIG. 26 illustrates a flowchart of a method for sending an inter-UE co-ordination information according to embodiments of the present disclosure;

FIG. 27 illustrates another flowchart of a method for sending an inter-UE co-ordination information according to embodiments of the present disclosure; and

FIG. 28 illustrates yet another flowchart of a method for sending an inter-UE co-ordination information according to embodiments of the present disclosure.

### DETAILED DESCRIPTION

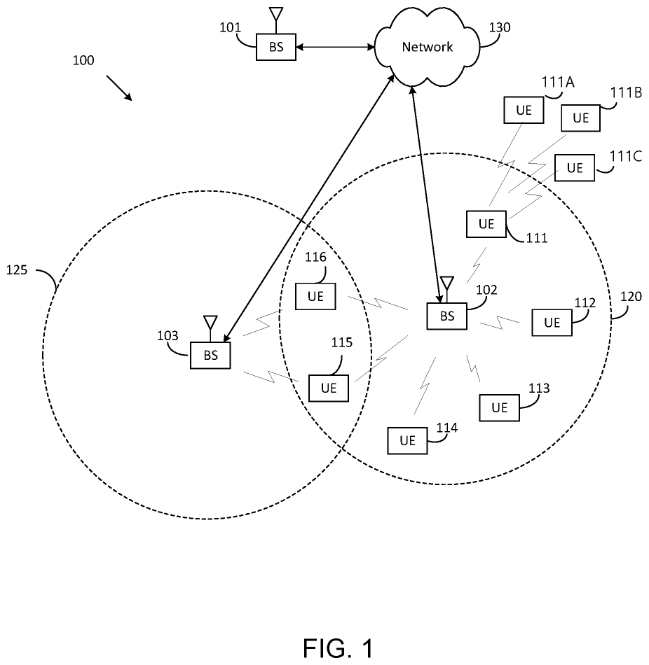

FIG. 1 through FIG. 28, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v17.4.0, “NR; Physical channels and modulation”; 3GPP TS 38.212 v17.4.0, “NR; Multiplexing and Channel coding”; 3GPP TS 38.213 v17.4.0, “NR; Physical Layer Procedures for Control”; 3GPP TS 38.214 v17.4.0, “NR; Physical Layer Procedures for Data”; 3GPP TS 38.321 v17.3.0, “NR; Medium Access Control (MAC) protocol specification”; 3GPP TS 38.331 v17.3.0, “NR; Radio Resource Control (RRC) Protocol Specification”; and 3GPP TS 36.213 v17.4.0, “Evolved Universal Terrestrial Radio Access (E-UTRA); Physical layer procedures.”

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of the present disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

In another example, the UE 116 may be within network coverage and the other UE may be outside network coverage (e.g., UEs 111A-111C). In yet another example, both UE are outside network coverage. In some embodiments, one or more of the gNBs 101-103 may communicate with each other and with the UEs 111-116 using 5G/NR, LTE, LTE-A, WiMAX, WiFi, or other wireless communication techniques. In some embodiments, the UEs 111-116 may use a device to device (D2D) interface called PC5 (e.g., also known as sidelink at the physical layer) for communication.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for sending and/or receiving signaling for an LTE/NR SL co-existence in a wireless communication system. In certain embodiments, and one or more of the gNBs 101-103 includes circuitry, programing, or a combination thereof, to support signaling for an LTE/NR SL co-existence in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As discussed in greater detail below, the wireless network 100 may have communications facilitated via one or more devices (e.g., UEs 111A to 111C) that may have a SL communication with the UE 111. The UE 111 can communicate directly with the UEs 111A to 111C through a set of SLs (e.g., SL interfaces) to provide sideline communication, for example, in situations where the UEs 111A to 111C are remotely located or otherwise in need of facilitation for network access connections (e.g., BS 102) beyond or in addition to traditional fronthaul and/or backhaul connections/interfaces. In one example, the UE 111 can have direct communication, through the SL communication, with UEs 111A to 111C with or without support by the BS 102. Various of the UEs (e.g., as depicted by UEs 112 to 116) may be capable of one or more communication with their other UEs (such as UEs 111A to 111C as for UE 111).

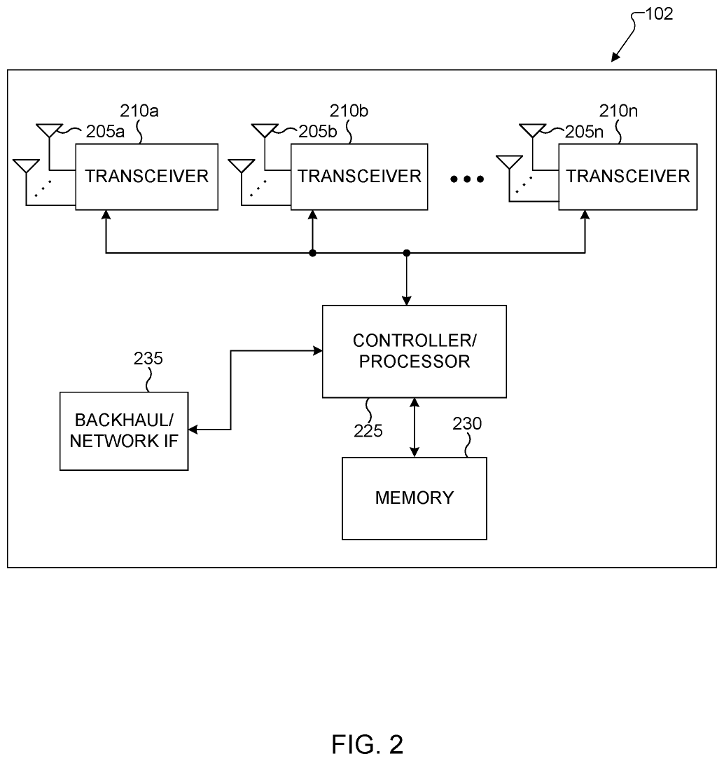

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process. The controller/processor 225 is also capable of executing programs and other processes resident in the memory 230, such as processes to provide or support a signaling for an LTE/NR SL co-existence in a wireless communication system.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

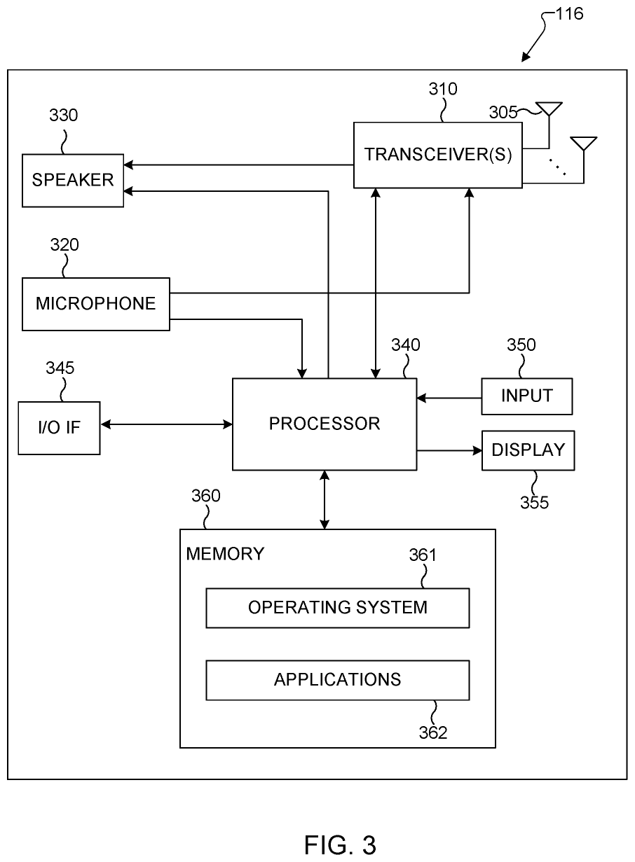

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100 or by other UEs (e.g., one or more of UEs 111-115) on a SL channel. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL and/or SL channels and/or signals and the transmission of UL and/or SL channels and/or signals by the transceiver(s) 310 in accordance with well-known principles. In some embodiments, the processor 340 includes at least one microprocessor or microcontroller.

The processor 340 is also capable of executing other processes and programs resident in the memory 360, such as processes for a signaling for an LTE/NR SL co-existence in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

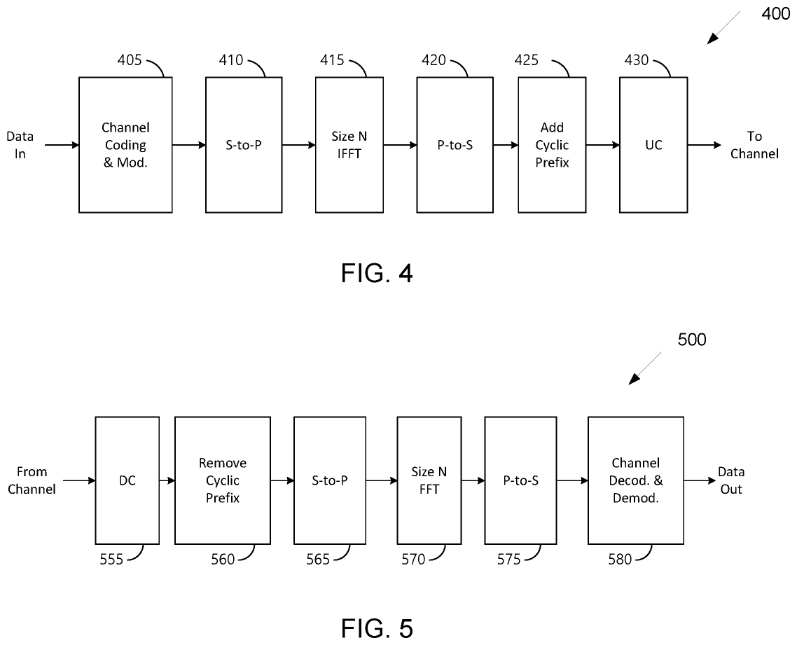

FIG. 4 and FIG. 5 illustrate example wireless transmit and receive paths according to the present disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. It may also be understood that the receive path 500 can be implemented in a first UE and that the transmit path 400 can be implemented in a second UE (or vice versa) to support SL communications. In some embodiments, the transmit path 400 and/or the receive path 500 is configured to support a signaling for an LTE/NR SL co-existence in a wireless communication system as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. In the example where a UE (e.g., UE 111) has direct communication, through the SL communication, with other UEs (e.g., with UEs 111A to 111C) with or without support by a BS (e.g., the BS 102), a transmitted RF signal from a first UE arrives at a second UE after passing through the wireless channel, and reverse operations to those at the first UE are performed at the second UE.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and/or transmitting in the sidelink to another UE and may implement the receive path 500 for receiving in the downlink from the gNBs 101-103 and/or receiving in the sidelink from another UE.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of the present disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A time unit for DL signaling, for UL signaling, or for SL signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. As another example, a slot can have a duration of 0.25 milliseconds and include 14 symbols and an RB can have a BW of 720 kHz and include 12 SCs with SC spacing of 60 kHz. An RB in one symbol of a slot is referred to as physical RB (PRB) and includes a number of resource elements (REs). A slot can be either full DL slot, or full UL slot, or hybrid slot similar to a special subframe in time division duplex (TDD) systems. In addition, a slot can have symbols for SL communications. A UE can be configured one or more bandwidth parts (BWPs) of a system BW for transmissions or receptions of signals or channels.

SL signals and channels are transmitted and received on sub-channels within a resource pool, where a resource pool is a set of time-frequency resources used for SL transmission and reception within a SL BWP. SL channels include physical SL shared channels (PSSCHs) conveying data information and second stage/part SCI, physical SL control channels (PSCCHs) conveying first stage/part SCI for scheduling transmissions/receptions of PSSCHs, physical SL feedback channels (PSFCHs) conveying hybrid automatic repeat request acknowledgement (HARQ-ACK) information in response to correct (ACK value) or incorrect (NACK value) transport block receptions in respective PSSCHs, PSFCHs can also convey conflict information, and physical SL broadcast channel (PSBCH) conveying system information to assist in SL synchronization.

SL signals include demodulation reference signals DM-RS that are multiplexed in PSSCH or PSCCH transmissions to assist with data or SCI demodulation, channel state information reference signals (CSI-RS) for channel measurements, phase tracking reference signals (PT-RS) for tracking a carrier phase, and SL primary synchronization signals (S-PSS) and SL secondary synchronization signals (S-SSS) for SL synchronization. SCI can include two parts/stages corresponding to two respective SCI formats where, for example, the first SCI format is multiplexed on a PSCCH and the second SCI format is multiplexed along with SL data on a PSSCH that is transmitted in physical resources indicated by the first SCI format.

A SL channel can operate in different cast modes. In a unicast mode, a PSCCH/PSSCH conveys SL information from one UE to only one other UE. In a groupcast mode, a PSCCH/PSSCH conveys SL information from one UE to a group of UEs within a (pre-)configured set. In a broadcast mode, a PSCCH/PSSCH conveys SL information from one UE to all surrounding UEs. In NR release 16, there are two resource allocation modes for a PSCCH/PSSCH transmission. In resource allocation mode 1, a gNB schedules a UE on the SL and conveys scheduling information to the UE transmitting on the SL through a DCI format (e.g., DCI Format 3_0). In resource allocation mode 2, a UE schedules a SL transmission. SL transmissions can operate within network coverage where each UE is within the communication range of a gNB, outside network coverage where all UEs have no communication with any gNB, or with partial network coverage, where only some UEs are within the communication range of a gNB.

In case of groupcast PSCCH/PSSCH transmission, a UE can be (pre-)configured one of two options for reporting of HARQ-ACK information by the UE: (1) HARQ-ACK reporting option 1, a UE can attempt to decode a transport block (TB) in a PSSCH reception if, for example, the UE detects a SCI format scheduling the TB reception through a corresponding PSSCH. If the UE fails to correctly decode the TB, the UE multiplexes a negative acknowledgement (NACK) in a PSFCH transmission. In this option, the UE does not transmit a PSFCH with a positive acknowledgment (ACK) when the UE correctly decodes the TB; and (2) HARQ-ACK reporting option 2, a UE can attempt to decode a TB if, for example, the UE detects a SCI format that schedules a corresponding PSSCH. If the UE correctly decodes the TB, the UE multiplexes an ACK in a PSFCH transmission; otherwise, if the UE does not correctly decode the TB, the UE multiplexes a NACK in a PSFCH transmission.

In HARQ-ACK reporting option 1, when a UE that transmitted the PSSCH detects a NACK in a PSFCH reception, the UE can transmit another PSSCH with the TB (retransmission of the TB). In HARQ-ACK reporting option 2 when a UE that transmitted the PSSCH does not detect an ACK in a PSFCH reception, such as when the UE detects a NACK or does not detect a PSFCH reception, the UE can transmit another PSSCH with the TB.

A sidelink resource pool includes a set/pool of slots and a set/pool of RBs used for sidelink transmission and sidelink reception. A set of slots which belong to a sidelink resource pool can be denoted by {t′₀^{SL}, t′₁^{SL}, t′₂^{SL}, . . . , t′_{T′MAX-1}^{SL}} and can be configured, for example, at least using a bitmap. Where, T′_{MAX} is the number of SL slots in a resource pool in 1024 frames. Within each slot t′_{y}^{SL} of a sidelink resource pool, there are N_{subCH} contiguous sub-channels in the frequency domain for sidelink transmission, where N_{subCH} is provided by a higher-layer parameter. Subchannel m, where m is between 0 and N_{subCH}−1, is given by a set of n_{subCHsize} contiguous PRBs, given by n_{PRB}=n_{subCHstart}+m·n_{subCHsize}+1 where j=0, 1, . . . , n_{subCHsize}−1, n_{subCHstart} and n_{subCHsize} are provided by higher layer parameters.

For resource (re-)selection or re-evaluation in slot n, a UE can determine a set of available single-slot resources for transmission within a resource selection window [n+T₁, n+T₂], such that a single-slot resource for transmission, R_{xy} is defined as a set of L_{subcH} contiguous subchannels x+i, where i=0, 1, . . . , L_{subCH}−1 in slot t_{y}^{SL}. T₁ is determined by the UE such that, 0≤T₁≤T_{proc,1}^{SL}, where T_{proc,1}^{SL} is a PSSCH processing time for example as defined in 3GPP standard specification (TS 38.214). T₂ is determined by the UE such that T₂ₘᵢₙ≤T₂≤Remaining Packet Delay Budget, as long as T₂ₘᵢₙ<Remaining Packet Delay Budget, else T₂ is equal to the Remaining Packet Delay Budget. T₂ₘᵢₙ is a configured by higher layers and depends on the priority of the SL transmission.

The slots of a SL resource pool are determined as shown in TABLE 1.

```
1. Let set of slots that may belong to a resource be denoted by {t₀^{SL}, t₁^{SL},
t₂^{SL}, ... , t_{T}_{_{MAX}}₋₁^{SL}}, where 0 ≤ tᵢ^{SL} < 10240 × 2^{μ} , and 0 ≤ i < Tₘₐₓ . μ is
the sub-carrier spacing configuration. μ = 0 for a 15 kHz sub-carrier
spacing. μ = 1 for a 30 kHz sub-carrier spacing. μ = 2 for a 60 kHz
sub-carrier spacing. μ = 3 for a 120 kHz sub-carrier spacing. The slot
index is relative to slot#0 of SFN#0 (system frame number 0) of the
serving cell, or DFN#0 (direct frame number 0). The set of slots
includes all slots except:
  a. N_{S-SSB} slots that are configured for SL SS/PBCH Block (S-SSB).
  b. N_{nonSL} slots where at least one SL symbol is not not-semi-statically
  configured as UL symbol by higher layer parameter tdd-UL-DL-
  ConfigurationCommon or sl-TDD-Configuration. In a SL slot, OFDM
  symbols Y-th, (Y+1)-th, . . . ., (Y+X-1)-th are SL symbols, where
  Y is determined by the higher layer parameter sl-StartSymbol and
  X is determined by higher layer parameter sl-LengthSymbols.
  c. N_{reserved} reserved slots. Reserved slots are determined such that the
  slots in the set {t₀^{SL}, t₁^{SL}, t₂^{SL}, ... , t_{T}_{_{MAX}}₋₁^{SL}} is a multiple of the
  bitmap length (L_{bitmap}), where the bitmap (b₀, b₁, ... , b_{L}_{_{bitmap}}₋₁) is
  configured by higher layers. The reserved slots are determined as
  follows:
    i. Let {l₀, l₁, ... , l₂_{^{μ}}_{×10240-N}_{_{S−SSB}}_{-N}_{_{nonSL}}₋₁} be the set of slots in range
    0 . . . 2^{μ} × 10240 − 1, excluding S-SSB slots and non-SL slots.
    The slots are arranged in ascending order of the slot index.
    ii. The number of reserved slots is given by: N_{reserved} = (2^{μ} ×
    10240 − N_{S-SSB} − N_{nonSL}) mod L_{bitmap}.
    iii. The reserved slots lᵣ are given by: r =
    $⌊ \frac{m \cdot ( {2}^{μ} \times 10240 - {N}_{S - SSB} - {N}_{nonSL} )}{{N}_{reserved}} ⌋ , where m = 0 , 1 , ... ,$
    N_{reserved} − 1
Tₘₐₓ is given by: Tₘₐₓ = 2^{μ} × 10240 − N_{S-SSB} − N_{nonSL} − N_{reserved}.
2. The slots are arranged in ascending order of slot index.
3. The set of slots belonging to the SL resource pool, {t′₀^{SL}, t′₁^{SL}, t′₂^{SL}, ... ,
t′_{T ′}_{_{MAX}}₋₁^{SL}}, are determined as follows:
  a. Each resource pool has a corresponding bitmap (b₀, b₁, ... , b_{L}_{_{bitmap}}₋₁)
  of length L_{bitmap}.
  b. A slot tₖ^{SL} belongs to the SL resource pool if b_{k mod L}_{_{bitmap}} = 1
  c. The remaining slots are indexed successively staring from 0, 1, . . .
  T′_{MAX} − 1.
  Where, T′_{MAX} is the number of remaining slots in the set.
```

Slots can be numbered (indexed) as physical slots or logical slots, wherein physical slots include all slots numbered sequential, while logical slots include only slots that can be allocated to sidelink resource pool as described above numbered sequentially. The conversion from a physical duration, Pᵣₛᵥₚ, in milli-second to logical slots, P′ᵣₛᵥₚ, is given by

$${P}_{rsvp}^{′} = ⌈ \frac{{T}_{max}^{′}}{10240 ms} \times {P}_{rsvp} ⌉$$

(as illustrated in 3GPP standard specification 38.214).

For resource (re-)selection or re-evaluation in slot n, a UE can determine a set of available single-slot resources for transmission within a resource selection window [n+T₁, n+T₂], such that a single-slot resource for transmission, R_{x,y} is defined as a set of L_{subCH} contiguous subchannels x+i, where i=0, 1, . . . , L_{subCH}−1 in slot t_{y}^{SL}. T₁ is determined by the UE such that, 0≤T₁≤T_{proc,1}^{SL}, where T_{proc,1}^{SL} is a PSSCH processing time for example as defined in 3GPP standard specification (38.214). T₂ is determined by the UE such that T₂ₘᵢₙ≤T₂≤Remaining Packet Delay Budget, as long as T₂ₘᵢₙ<Remaining Packet Delay Budget, else T₂ is equal to the Remaining Packet Delay Budget. T₂ₘᵢₙ is configured by higher layers and depends on the priority of the SL transmission.

The resource (re-)selection is a two-step procedure: (1) the first step (e.g., performed in the physical layer) is to identify the candidate resources within a resource selection window. Candidate resources are resources that belong to a resource pool, but exclude resources (e.g., resource exclusion) that were previously reserved, or potentially reserved by other UEs. The resources excluded are based on SCIs decoded in a sensing window and for which the UE measures a SL RSRP that exceeds a threshold. The threshold depends on the priority indicated in a SCI format and on the priority of the SL transmission. Therefore, sensing within a sensing window involves decoding the first stage SCI, and measuring the corresponding SL RSRP, wherein the SL RSRP can be based on PSCCH DMRS or PSSCH DMRS. Sensing is performed over slots where the UE doesn't transmit SL. The resources excluded are based on reserved transmissions or semi-persistent transmissions that can collide with the excluded resources or any of reserved or semi-persistent transmissions, the identified candidate resources after resource exclusion are provided to higher layers; and (2) the second step (e.g., preformed in the higher layers) is to select or re-select a resource from the identified candidate resources.

During the first step of the resource (re-)selection procedure, a UE can monitor slots in a sensing window [n−T₀, n−T_{proc,0}), where the UE monitors slots belonging to a corresponding sidelink resource pool that are not used for the UE's own transmission.

To determine a candidate single-slot resource set to report to higher layers, a UE excludes (e.g., resource exclusion) from the set of available single-slot resources for SL transmission within a resource pool and within a resource selection window, as shown in TABLE 2.

```
TABLE 2
1. Single slot resource R_{x,y}, such that for any slot t′ₘ^{SL} not monitored
within the sensing window with a hypothetical received SCI Format 1-0,
with a “Resource reservation period” set to any periodicity value allowed
by a higher layer parameter reseverationPeriodAllowed, and indicating all
sub-channels of the resource pool in this slot, satisfies condition 2.2.
below.
2. Single slot resource R_{x,y}, such that for any received SCI within the
sensing window:
  1. The associated L1-RSRP measurement is above a (pre-)configured
  SL-RSRP threshold, where the SL-RSRP threshold depends on the
  priority indicated in the received SCI and that of the SL transmission
  for which resources are being selected.
  2. (Condition 2.2) The received SCI in slot t′ₘ^{SL}, or if “Resource
  reservation field” is present in the received SCI the same SCI is
  assumed to be received in slot t′_{m+q×P′}_{ᵣₛᵥₚ}_Rx^{SL}, indicates a set of
  resource blocks that overlaps R_{x,y+j×P′}_{ᵣₛᵥₚ}_Tx.
  Where,
    ▪ q = 1,2, ... , Q, where,
      $If {P}_{rsvp\_RX} \leq {T}_{scal} and {n}^{′} - m < {P}_{rsvp\_Rx}^{′} \to Q = ⌈ \frac{{T}_{scal}}{{P}_{rsvp\_RX}} ⌉ .$
      T_{scal} is T₂ in units of milli-seconds.
      • Else Q = 1
      • If n belongs to (t′₀^{SL}, t′₁^{SL}, ... , t′_{T ′}_{_{max−1}}^{SL}), n′ = n, else n′ is the
      first slot after slot n belonging to set (t′₀^{SL}, t′₁^{SL}, ... , t′_{T ′}_{ₘₐₓ}₋₁^{SL}).
    ▪ j = 0, 1, ... , Cᵣₑₛₑₗ − 1
    ▪ Pᵣₛᵥₚ_RX is the indicated resource reservation period in the received
    SCI in physical slots, and P′ᵣₛᵥₚ_Rx is that value converted to logical
    slots.
    ▪ P′ᵣₛᵥₚ_Tx is the resource reservation period of the SL transmissions
    for which resources are being reserved in logical slots.
3. If the candidate resources are less than a (pre-)configured percentage,
such as 20%, of the total available resources within the resource selection
window, the (pre-)configured SL-RSRP thresholds are increased by a
predetermined amount, such as 3 dB.
```

An NR sidelink introduced two new procedures for mode 2 resource allocation; re-evaluation and pre-emption.

Re-evaluation check occurs when a UE checks the availability of pre-selected SL resources before the resources are first signaled in an SCI Format, and if needed re-selects new SL resources. For a pre-selected resource to be first-time signaled in slot m, the UE performs a re-evaluation check at least in slot m−T₃.

The re-evaluation check includes: (1) performing the first step of the SL resource selection procedure (as illustrated in 3GPP standard specification TS 38.214), which involves identifying a candidate (available) sidelink resource set in a resource selection window as previously described; (2) if the pre-selected resource is available in the candidate sidelink resource set, the resource is used/signaled for sidelink transmission; and (3) else, the pre-selected resource is not available in the candidate sidelink resource set, a new sidelink resource is re-selected from the candidate sidelink resource set.

A pre-emption check occurs when a UE checks the availability of pre-selected SL resources that have been previously signaled and reserved in an SCI Format, and if needed re-selects new SL resources. For a pre-selected and reserved resource to be signaled in slot m, the UE performs a pre-emption check at least in slot m−T₃.

When pre-emption check is enabled by higher layers, pre-emption check includes: (1) performing the first step of the SL resource selection procedure (as illustrated in 3GPP standard specification TS 38.214), which involves identifying candidate (available) sidelink resource set in a resource selection window as previously described; (2) if the pre-selected and reserved resource is available in the candidate sidelink resource set, the resource is used/signaled for sidelink transmission; and (3) else, the pre-selected and reserved resource is NOT available in the candidate sidelink resource set. The resource is excluded from the candidate resource set due to an SCI, associated with a priority value PRX, having an RSRP exceeding a threshold. Let the priority value of the sidelink resource being checked for pre-emption be P_{TX}.

In such examples, if the priority value P_{RX} is less than a higher-layer configured threshold and the priority value P_{RX} is less than the priority value P_{TX}. The pre-selected and reserved sidelink resource is pre-empted. A new sidelink resource is re-selected from the candidate sidelink resource set. Note that, a lower priority value indicates traffic of higher priority, else, the resource is used/signaled for sidelink transmission.

As described in the present disclosure, the monitoring procedure for resource (re)selection during the sensing window requires reception and decoding of a SCI format during the sensing window as well as measuring the SL RSRP. This reception and decoding process and measuring the SL RSRP increases a processing complexity and power consumption of a UE for sidelink communication and requires the UE to have receive circuitry on the SL for sensing even if the UE only transmits and does not receive on the sidelink.

3GPP Release 16 is the first NR release to include sidelink through work item “5G V2X with NR sidelink,” the mechanisms introduced focused mainly on vehicle-to-everything (V2X), and can be used for public safety when the service requirement can be met. Release 17 extends sidelink support to more use cases through work item “NR Sidelink enhancement.” The objectives of Rel-17 SL include: (1) resource allocation enhancements that reduce power consumption. (2) enhanced reliability and reduced latency. Release 18 considers further evolution of the NR SL air interface for operation in unlicensed bands, beam-based operation in FR2, SL carrier aggregation and co-channel co-existence between LTE SL and NR SL.

The present disclosure considers dynamic co-channel co-existence between LTE SL and NR SL. A UE includes two modules, an LTE SL module and an NR SL module. The modules exchange messages to enable the NR SL module to adapt the NR SL traffic based on existing LTE SL traffic. In this disclosure, the messages exchanged between the LTE SL module and the NR SL module is provided.

3GPP Release 16 is the first NR release to include sidelink through work item “5G V2X with NR sidelink,” the mechanisms introduced focused mainly on vehicle-to-everything (V2X), and can be used for public safety when the service requirement can be met. Release 17 extends sidelink support to more use cases through work item “NR Sidelink enhancement.”

Release 18 considers further evolution of the NR SL air interface for operation in unlicensed bands, beam-based operation in FR2, SL carrier aggregation and co-channel co-existence between LTE SL and NR SL. The automotive industry has identified LTE SL/NR SL co-existence as one of the 3 top priorities for further evolution of SL. In one example, co-existence can be static or semi-static co-existence. A set of resources is allocated for LTE SL and a non-overlapping setting of resources is allocated to NR SL. Such static or semi-static allocation can lead to less efficient operation as it does not take into account short term variations in the LTE SL traffic and NR SL traffic, that can cause one set of resources to be lightly utilized and a second set of resources to heavily utilized at one point in time and vice versa at a second point time.

To address the inefficiencies of semi-static allocation, a more dynamic spectrum (resource) sharing approach can be considered, wherein the resources can be used by LTE SL and NR SL. Without further enhancements, this can lead to increased collisions between LTE SL traffic and NR SL traffic, leading to a higher BLER and hence reduced capacity. To over-come this, some co-ordination is required between the LTE SL module and the NR SL module in a UE that supports both air interfaces. In this disclosure, the messages exchanged between the LTE SL module and the NR SL module to allow for a more dynamic co-channel co-existence is provided.

The present disclosure relates to a 5G/NR communication system.

The present disclosure considers the content of signaling messages between LTE SL module and NR SL module for co-channel co-existence between LTE SL and NR SL.

In some embodiments, LTE SL and NR SL can coexist. The coexistence of LTE SL and NR SL can be according to the following examples, in these examples a resource refers to a time-frequency resource.

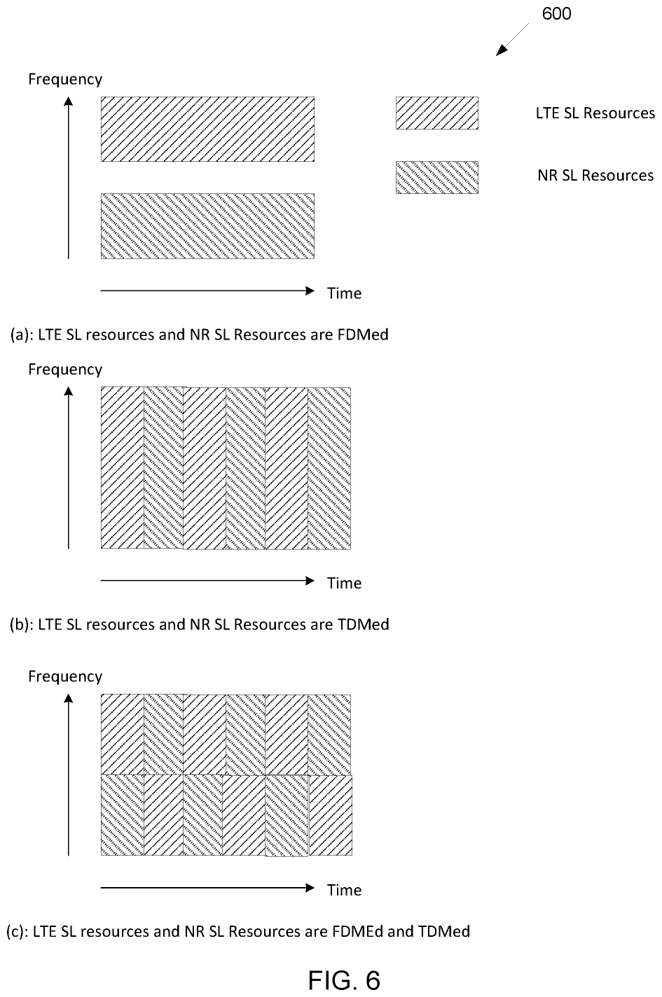

FIG. 6 illustrates an example of LTE SL resources and NR SL resources 600 according to embodiments of the present disclosure. An embodiment of the LTE SL resources and NR SL resources 600 shown in FIG. 6 is for illustration only.

In one example, LTE SL resources and NR SL resources are not overlapping, separate resources can be used for LTE SL and separate resources can be used for NR SL. For example, the LTE SL resources and the NR SL resources can be frequency division multiplexed as illustrated in FIG. 6 (e.g., (a) of FIG. 6), or can be time division multiplexed as illustrated in FIG. 6 (e.g., (b) of FIG. 6), or a mixture of time and frequency division multiplexing as illustrated in FIG. 6 (e.g., (c) of FIG. 6).

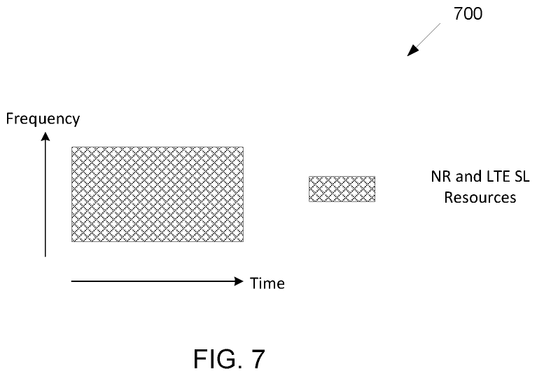

FIG. 7 illustrates an example of NR and LTE SL resources 700 according to embodiments of the present disclosure. An embodiment of the NR and LTE SL resources 700 shown in FIG. 7 is for illustration only.

In another example, LTE SL resources and NR SL resources are fully overlapping. This is illustrated in FIG. 7.

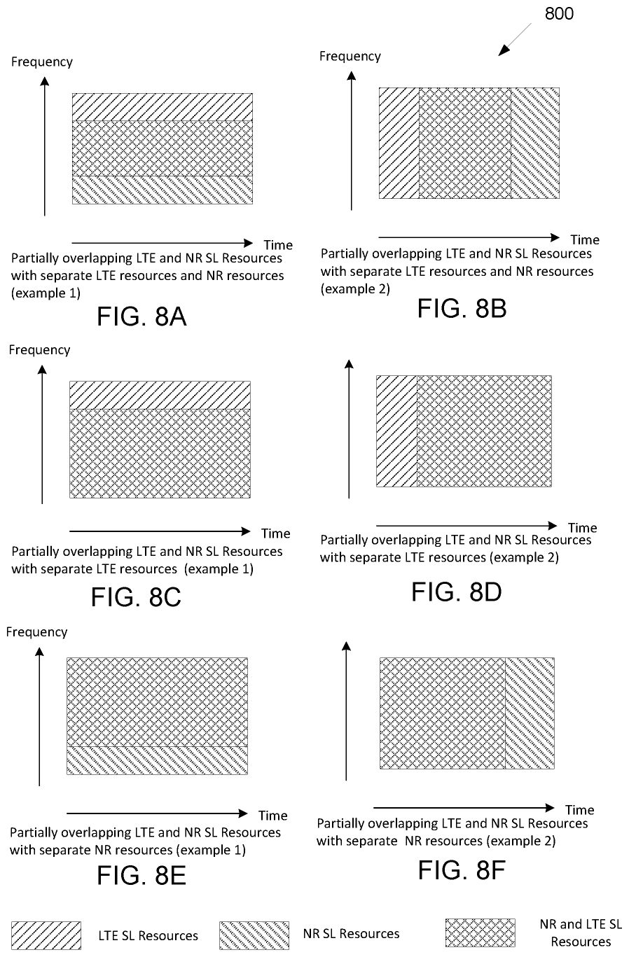

FIGS. 8A-8F illustrate an example of LTE SL resources, NR SL resources, and LTE and NR SL resources 800 according to embodiments of the present disclosure. An embodiment of the LTE SL resources, NR SL resources, and LTE and NR SL resources 800 shown in FIGS. 8A-8F is for illustration only.

In another example, LTE SL resources and NR SL resources are partially overlapping. This is illustrated in FIGS. 8A-8F. This can include the following examples.

In one example, some resources are used for LTE SL and NR SL, other resources are used for LTE SL only, while other resources are used for NR SL only. This is illustrated by way of example in FIGS. 8A and 8B.

In one example, some resources are used for LTE SL and NR SL and other resources are used for LTE SL only. This is illustrated by way of example in FIG. 8C and 8D.

In one example, some resources are used for LTE SL and NR SL and other resources are used for NR SL only. This is illustrated by way of example in FIGS. 8E and 8F.

In the present disclosure, resources shared by NR SL and LTE SL is provided, wherein the sharing of resources between LTE SL and NR SL can be full sharing of resources or partial sensing of resources.

In one example, the resources shared by LTE and NR SL UEs can be configured to be used by one of the following:
(1) LTE SL UEs and (2) NR SL UEs that support dynamic channel co-existence with LTE SL UEs;
(1) LTE SL UEs and (2) any NR SL UE whether or not it supports dynamic channel co-existence with LTE SL UEs;
(1) LTE SL UE and (2) any NR SL UE whether or not it supports dynamic channel co-existence with LTE SL UEs. UEs that do not support dynamic channel co-existence with LTE SL UEs can only receive SL (no transmissions) on resources that are shared with LTE SL; or
(1) LTE SL UE and (2) any NR SL UE whether or not it supports dynamic channel co-existence with LTE SL UEs. NR SL UEs can receive inter-UE co-ordination information that can include preferred or non-preferred resources or conflicts with respect to LTE resource reservations. UEs that do not support dynamic channel co-existence with LTE SL UEs and do not support inter-UE co-ordination information can only receive SL (no transmissions) on resources that are shared with LTE SL.

In the above, dynamic channel co-existence with LTE SL UEs can for example refer to the ability of the NR SL UE to avoid resources reserved by an LTE SL UE.

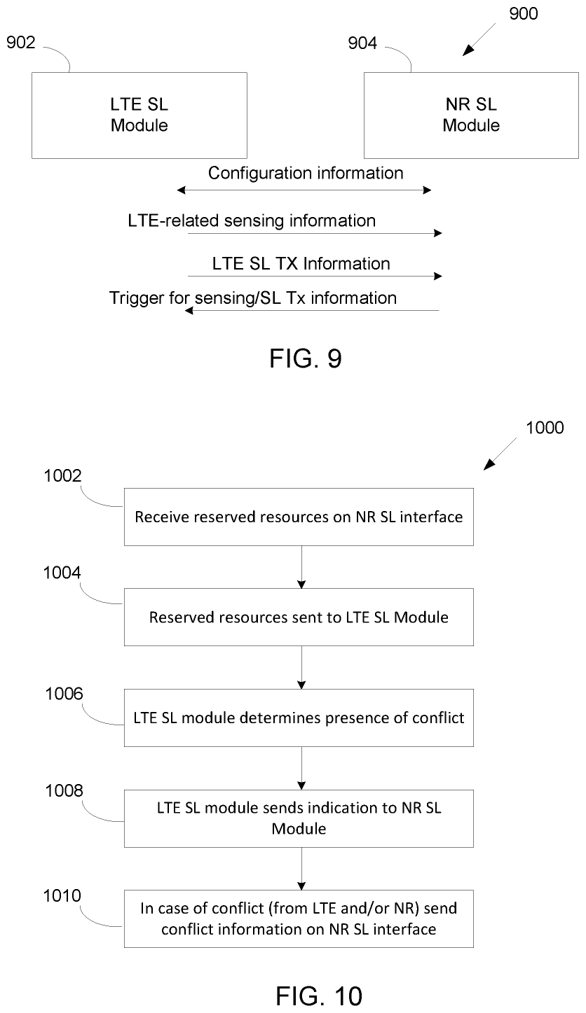

FIG. 9 illustrates an example of UE modules (or entities) 900 according to embodiments of the present disclosure. An embodiment of the UE modules 900 shown in FIG. 9 is for illustration only. For example, the UE modules 900 may be included in any of the UEs 111-116. The UE includes two modules as illustrated in FIG. 9: (1) an LTE SL module (or entity) 902 and (2) an NR SL module (or entity) 904. For example, the LTE SL module 902 has a radio interface, e.g., via transceiver 310, and communicates according to LTE and or 4G protocols and standards. The NR SL module 904 has a radio interface, e.g., via transceiver 310, and communicates according to NR or 5G protocols and standards. The modules 902 and 904 are connected and can exchange information, e.g., via intra UE communication.

In one example, the LTE SL module 902 performs sensing and provides the NR SL module 904 LTE-based sensing results (sensing information).

FIG. 9 illustrates example of message exchange between LTE SL module 902 and NR SL module. Information exchanged can include: (1) configuration information; (2) LTE-related sensing information; (3) LTE SL transmission information; and (4) trigger for sensing or LTE SL transmission information.

The NR SL module 904 and the LTE SL module 902 can exchange the following configuration information: (1) configuration information related to the NR SL Tx resource pool or pools from NR SL module 904 to LTE SL module 902; (2) configuration information related to the SL transmission in NR SL Tx resource pool or pools from NR SL module 904 to LTE SL module 902; and/or (3) configuration information related to the LTE SL Tx resource pool or pools from LTE SL module 902 to NR SL module.

Configuration information related to the NR SL Tx resource pool or pools including: (1) a time domain configuration, slots included in the NR SL Tx resource pool or pools, one or more of the following parameters can be provided (i.e., the logic slots of the resource pool and the slot structure): (i) N_{S_SSB} slots in which S-SS/PSBCH block (S-SSB) is configured, (ii) N_{nonSL} slots in each of which at least one of Y-th, (Y+1)-th, . . . , (Y+X−1)-th OFDM symbols are not semi-statically configured as UL as per the higher layer parameter tdd-UL-DL-ConfigurationCommon of the serving cell if provided or sl-TDD-Configuration if provided or sl-TDD-Config of the received PSBCH if provided, where Y and X are set by the higher layer parameters sl-StartSyrnbol and sl-LengthSyrnbols, respectively, (iii) the reserved slots, (iv) a bitmap of the resource pool provided by higher layer parameter sl-TimeResource, and/or (iv) structure of SL slot including Y and X set by the higher layer parameters sl-StartSyrnbol and sl-LengthSyrnbols; and (2) frequency domain configuration of the NR SL Tx resource pool or pools, one or more of the following parameters can be provided: (i) the lowest RB index of the subchannel with the lowest index in the resource pool with respect to the lowest RB index of a SL BWP given by higher layer parameter sl-StartRB-Subchannel, (ii) the minimum granularity in frequency domain for the sensing for PSSCH resource selection (sub-channel size) in the unit of PRB given by higher layer parameter sl-SubchannelSize, (iii) the number of PRB s in the corresponding resource pool given by higher layer parameter sI-RB-Number, and/or (iv) the number of sub-channels in the corresponding resource pool given by higher layer parameter sl-NumSubchannel.

In one example, the LTE SL module 902 provides sensing results to the NR SL module 904 for single slot resources corresponding to the NR SL Tx resource pool or pools, e.g., based on the configuration information.

Configuration information related to the SL transmission in NR SL Tx resource pool or pools, can include one or more of the following: (1) priority level of SL transmission; (2) number of subchannels used for the SL transmission; (3) transport block size of the SL transmission; and/or (4) whether the SL transmission is periodic or aperiodic and periodicity of SL transmission if periodic.

Configuration information related to the LTE SL Tx resource pool or pools including: (1) time domain configuration, slots included in the LTE SL resource pool or pools (e.g., logical LTE SL sub-frames); and/or (2) frequency domain configuration of the LTE SL resource pool or pools.

During sensing, the UE attempts to decode PSCCH and measure the RSRP of the SL transmission. The RSRP measurement can be based on the PSCCH DMRS or the PSSCH DMRS. When the UE successfully decodes the PSCCH, the LTE SL module 902 can provide one or more of the following sensing results (sensing information to the NR SL module): (1) resource of PSSCH corresponding to the decoded PSCCH (i.e., decoded SCI format in PSCCH), including: (i) the sub-frame, (ii) the starting sub-channel, and (iii) the number of sub-channels; (2) aperiodic resources reserved by PSCCH (i.e., decoded SCI format in PSCCH), including for each reserved resource: (i) the subframe of the reserved resource or the number of subframes between the subframe of the PSCCH and the subframe of the reserved resource, and (ii) the starting subchannel of reserved resource; (3) the periodicity associated with the decoded PSCCH (i.e., decoded SCI format in PSCCH); (4) the priority associated with the decoded PSCCH (i.e., decoded SCI format in PSCCH); and (5) the RSRP associated with the decoded PSCCH (based on the PSCCH DMRS or the PSSCH DMRS).

Additional conditions for provision of sensing results from the LTE SL module 902 to the NR SL module. One or more of the following examples can be applied.

In one example, an RSRP threshold is provided. Wherein, the RSRP threshold can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI).

In one such example, if the decoded PSCCH has an RSRP that is greater than (or greater than or equal to) the RSRP threshold, sensing information is provided from the LTE SL module 902 to the NR SL module 904.

In one such example, if the decoded PSCCH has an RSRP that is less than (or less than or equal to) the RSRP threshold, sensing information is provided from the LTE SL module 902 to the NR SL module 904.

In one such example, the RSRP threshold is provided by the NR SL module 904 to the LTE SL module 902. In a variant example, the sensing information is sent to the NR module, and the NR module excludes the sensing information associated with an RSRP that is less than (or less than or equal to) the RSRP threshold, when determining the NR SL candidate resources.

In one example, an RSRP threshold is provided per Rx priority level. The Rx priority level is the priority level signaled by the decoded PSCCH. Wherein, the RSRP threshold per Rx priority level can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI).

In one such example, if the decoded PSCCH with a priority level has an RSRP that is greater than (or greater than or equal to) the RSRP threshold of the corresponding Rx priority level, sensing information is provided from the LTE SL module 902 to the NR SL module 904.

In one such example, if the decoded PSCCH with a priority level has an RSRP that is less than (or less than or equal to) the RSRP threshold of the corresponding Rx priority level, sensing information is provided from the LTE SL module 902 to the NR SL module 904.

In one such example, the RSRP threshold per Rx priority level is provided by the NR SL module 904 to the LTE SL module 902. In a variant example, the sensing information is sent to the NR module, and the NR module excludes the sensing information associated with an RSRP that is less than (or less than or equal to) the RSRP threshold of the corresponding Rx priority level, when determining the NR SL candidate resources.

In one example, an RSRP threshold is provided per Tx priority level. The TX priority level is the priority level of a Tx transmission that can be signaled from the NR SL module 904 to the LTE SL module 902. Wherein, the RSRP threshold per Tx priority level can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI).

In one such example, if the decoded PSCCH has an RSRP that is greater than (or greater than or equal to) the RSRP threshold of the corresponding Tx priority level, sensing information is provided from the LTE SL module 902 to the NR SL module 904.

In one such example, if the decoded PSCCH has an RSRP that is less than (or less than or equal to) the RSRP threshold of the corresponding Tx priority level, sensing information is provided from the LTE SL module 902 to the NR SL module 904.

In one such example, the RSRP threshold per Tx priority level is provided by the NR SL module 904 to the LTE SL module 902. In a variant example, the sensing information is sent to the NR module, and the NR module excludes the sensing information associated with an RSRP that is less than (or less than or equal to) the RSRP threshold per Tx priority level, when determining the NR SL candidate resources.

In one example, an RSRP threshold is provided per Rx priority level and per Tx priority level. The Rx priority level is the priority level signaled by the decoded PSCCH. The TX priority level is the priority level of a Tx transmission that can be signaled from the NR SL module 904 to the LTE SL module 902. Wherein, the RSRP threshold per Rx priority level and per Tx priority level can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI).

In one such example, if the decoded PSCCH with a priority level has an RSRP that is greater than (or greater than or equal to) the RSRP threshold of the corresponding Rx priority level and Tx priority level, sensing information is provided from the LTE SL module 902 to the NR SL module 904.

In one such example, if the decoded PSCCH with a priority level has an RSRP that is less than (or less than or equal to) the RSRP threshold of the corresponding Rx priority level and Tx priority level, sensing information is provided from the LTE SL module 902 to the NR SL module 904.

In one such example, the RSRP threshold per Rx priority level and per Tx priority level is provided by the NR SL module 904 to the LTE SL module 902. In a variant example, the sensing information is sent to the NR module, and the NR module excludes the sensing information associated with an RSRP that is less than (or less than or equal to) the RSRP threshold per Rx priority level and per Tx priority level, when determining the NR SL candidate resources.

In one example, a Rx priority threshold is provided. The Rx priority level is the priority level signaled by the decoded PSCCH. Wherein, the Rx priority threshold can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI).

In one such example, if the decoded PSCCH includes a priority level that is greater than (or greater than or equal to) the Rx priority threshold, sensing information is provided from the LTE SL module 902 to the NR SL module 904.

In one such example, if the decoded PSCCH includes a priority level that is less than (or less than or equal to) the Rx priority threshold, sensing information is provided from the LTE SL module 902 to the NR SL module 904.

In one such example, the RSRP threshold per Rx priority threshold is provided by the NR SL module 904 to the LTE SL module 902. In a variant example, the sensing information is sent to the NR module, and the NR module excludes the sensing information associated with an Rx priority level (from the decoded PSCCH on LTE) that is greater than (or greater than or equal to) Rx priority threshold, when determining the NR SL candidate resources.

In one example, the LTE SL module 902 provides sensing results to the NR SL module 904 for single slot resources within the NR SL Tx resource pool or pools, e.g., based on the configuration information.

In one example, the LTE SL module 902 provides sensing results to the NR SL module 904 without taking into account any NR SL Tx resource pool resource pool configuration information.

Information related to SL transmissions from the LTE SL module 902, this can include: (1) resources used for SL transmission: (i) time domain resources: Subframes in LTE SL numerology or slots in NR SL numerology, and (ii) frequency domain resources: PRBs or sub-channels in LTE SL numerology or NR SL numerology (e.g., starting sub-channel and number of sub-channels); (2) periodicity of SL transmission; and (3) priority of SL transmission.

The trigger can include one or more of the following: (1) information related to NR SL transmission, this can include one or more of the following: (i) priority of sidelink transmission; (ii) whether traffic is periodic or aperiodic and incase of periodic traffic periodicity of SL transmission; (iii) packet delay budget, (iv) number of sub-channels of a SL transmission, and/or (v) transport block size of a SL transmission; and/or (2) timing information, e.g., one or more of the following: (i) start of resource selection window, (ii) end of resource selection window, (iii) length of resource selection window, (iv) start of sensing window, (v) end of sensing widow, and/or (vi) length of sensing window.

The LTE SL module 902 can provide the NR SL module 904 one or more of following information: (1) LTE-related sensing information and (2) LTE SL transmission information.

In one example, when NR SL module 904 receives information from the LTE SL module 902, the NR SL module 904 uses the information for resource exclusion for the identification of candidate NR SL resources for NR SL resource (re-)selection.

In one example, when NR SL module 904 receives information from the LTE SL module 902, the NR SL module 904 uses the information for determination if a reserved SL resource indicated by a second UE has a conflict and if it has a conflict, a confliction indication is transmitted to the second UE.

FIG. 10 illustrates a flowchart of a method 1000 for receiving reserved resources according to embodiments of the present disclosure. The method 1000 as may be performed by a UE (e.g., 111-116 as illustrated in FIG. 1). An embodiment of the method 1000 shown in FIG. 10 is for illustration only. One or more of the components illustrated in FIG. 10 can be implemented in specialized circuitry configured to perform the noted functions or one or more of the components can be implemented by one or more processors executing instructions to perform the noted functions.

As illustrated in FIG. 10, the method 100 begins at step 1002. In step 1002, a UE receives reserved resources on NR SL interface. In step 1004, the reserved resources sent to LTE SL module. In step 1006, the LTE SL module determines presence of conflict. In step 1008, the LTE SL module sends indication to an NR SL module. Finally, in step 1010, in case of conflict (from LTE and/or NR), conflict information is sent on NR SL interface.

In one example, as illustrated in FIG. 10, the NR SL module receives reserved resources from a second UE. The NR SL module provides the reserved resources to the LTE SL module, the LTE SL module can determine whether the reserved resource has a conflict or not. The conflict status of the reserved resource is indicated to the NR SL module. In one example, if the resource is in conflict, the LTE SL module sends an indication to the NR SL module, otherwise no indication is sent. In one example, if the resource is not in conflict, the LTE SL module sends an indication to the NR SL module, otherwise no indication is sent. In one example, if the resource is in conflict, the LTE SL module sends an indication to the NR SL module that the resources is in conflict, otherwise if the resource is not in conflict, the LTE SL module sends an indication to the NR SL module that the resource is not in conflict.

A conflict can occur if the reserved resource overlaps in time and frequency with a reserved LTE SL resource of another UE.

A conflict can occur if the reserved resource overlaps in time with an LTE SL transmission from the LTE SL module.

In one example, the occurrence of a conflict can be based on the priority of the reserved resource and the priority of the LTE SL reserved resource.

In one example, the occurrence of a conflict can be based on SL RSRP associated with the reserved resource compared to a threshold wherein the threshold can depend the priority of the reserved resource and/or the priority of the LTE SL reserved resource.

If the resource is indicated (explicitly or implicitly) as in conflict with an LTE SL transmission, a conflict indication is sent to the second UE. In one example, the reserved resource for which a conflict is indicated is the next in time reserved resource.

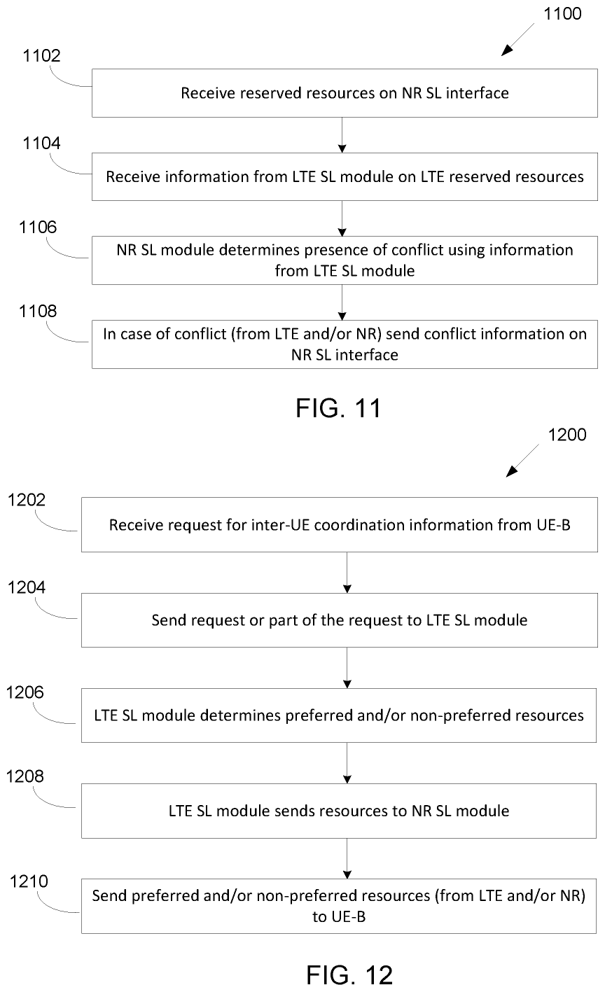

FIG. 11 illustrates another flowchart of a method 1100 for receiving reserved resources according to embodiments of the present disclosure. The method 1100 as may be performed by a UE (e.g., 111-116 as illustrated in FIG. 1). An embodiment of the method 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

As illustrated in FIG. 11, the method 1100 begins at step 1102. In step 1102, the UE receives reserved resources on NR SL interface. In step 1104, the NR module receives information from LTE SL module on LTE reserved resources. In step 1106, NR SL module determines presence of conflict using (e.g., based on) information from LTE SL module. Finally, in step 1108, in case of conflict (from LTE and/or NR), conflict information is sent on NR SL interface.

In one example, as illustrated in FIG. 11, the NR SL module receives reserved resources from a second UE. The NR SL module determines based on information provided by the LTE SL module whether the reserved resource is in conflict or not.

A conflict can occur if the reserved resource overlaps in time and frequency with a resource indicated by the LTE module as being unavailable.

A conflict can occur if the reserved resource overlaps in time with an LTE SL transmission from the LTE SL module.

In one example, the occurrence of a conflict can be based on the priority of the reserved resource and the priority of the LTE SL reserved resource.

In one example, the occurrence of a conflict can be based on SL RSRP associated with the reserved resource compared to a threshold wherein the threshold can depend the priority of the reserved resource and/or the priority of the LTE SL reserved resource.

If the reserved resource of the second UE is in conflict with an LTE SL transmission, a conflict indication is sent to the second UE. In one example, the reserved resource for which a conflict is indicated is the next in time reserved resource.

In one example, when NR SL module receives information from the LTE SL module, the NR SL module uses the information for determination of preferred and/or non-preferred resources to send to one or more second UEs.

FIG. 12 illustrates a flowchart of a method 1200 for receiving an inter-UE co-ordination request according to embodiments of the present disclosure. The method 1200 as may be performed by a UE (e.g., 111-116 as illustrated in FIG. 1). An embodiment of the method 1200 shown in FIG. 12 is for illustration only. One or more of the components illustrated in FIG. 12 can be implemented in specialized circuitry configured to perform the noted functions or one or more of the components can be implemented by one or more processors executing instructions to perform the noted functions.

As illustrated in FIG. 12, the method 1200 begins at step 1202. In step 1202, the UE receives a request for inter-UE coordination information from UE-B. In step 1204, the request or part of the request is sent to LTE SL module. In step 1206, an LTE SL module determines preferred and/or non-preferred resources. In step 1208, the LTE SL module sends resources to NR SL module. Finally, in step 1210, the preferred and/or non-preferred resources (from LTE and/or NR) is sent to UE-B.

In one example, as illustrated in FIG. 12, the NR SL module receives an inter-UE co-ordination request from a second UE. In response to the inter-UE co-ordination request, the NR SL module sends a request to the LTE SL module for information to assist in determining preferred or non-preferred resources for inter-UE co-ordination. The request sent to the LTE SL module can include information provided by the second UE in the inter-UE co-ordination request. The LTE SL module provides information to the NR SL module. Inter-UE co-ordination information is sent to the second UE using (e.g., based on) information provided by the LTE module.

In one example, the inter-UE co-ordination information includes preferred resources determined at least in part based on the information provided by the LTE module.

In one example, the inter-UE co-ordination information includes non-preferred resources determined at least in part based on the information provided by the LTE module.

In one example, the inter-UE co-ordination information includes preferred resources and non-preferred resources determined at least in part based on the information provided by the LTE module.

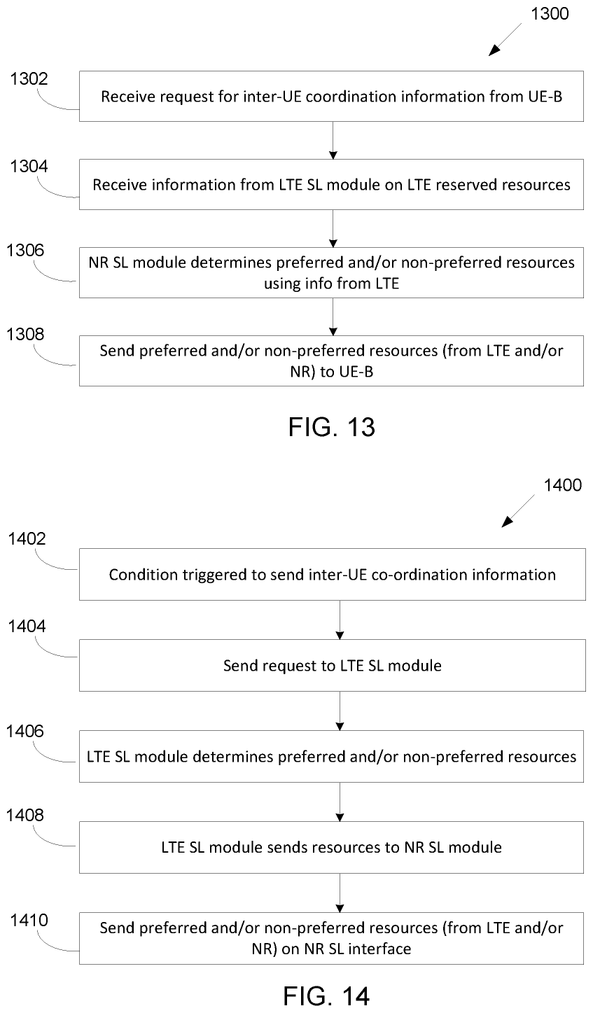

FIG. 13 illustrates a flowchart of a method 1300 for receiving an inter-UE co-ordination request according to embodiments of the present disclosure. The method 1300 as may be performed by a UE (e.g., 111-116 as illustrated in FIG. 1). An embodiment of the method 1300 shown in FIG. 13 is for illustration only. One or more of the components illustrated in FIG. 13 can be implemented in specialized circuitry configured to perform the noted functions or one or more of the components can be implemented by one or more processors executing instructions to perform the noted functions.

As illustrated in FIG. 13, the method 1300 begins at step 1302. In step 1302, the UE receives a request for inter-UE coordination information from UE-B. In step 1304, the NR module receives information from LTE SL module on LTE reserved resources. In step 1306, an NR SL module determines preferred and/or non-preferred resources using (e.g. based on) info from LTE. Finally, in step 1308, the preferred and/or non-preferred resources (from LTE and/or NR) is sent to UE-B.

In one example, as illustrated in FIG. 13, the NR SL module receives an inter-UE co-ordination request from a second UE. In response to the inter-UE co-ordination request, the NR SL module sends inter-UE co-ordination information to the second UE using (e.g., based on) information provided by the LTE module.

In one example, the inter-UE co-ordination information includes preferred resources determined at least in part based on the information provided by the LTE module.

In one example, the inter-UE co-ordination information includes non-preferred resources determined at least in part based on the information provided by the LTE module.

In one example, the inter-UE co-ordination information includes preferred resources and non-preferred resources determined at least in part based on the information provided by the LTE module.

FIG. 14 illustrates a flowchart of a method 1400 for sending an inter-UE co-ordination information according to embodiments of the present disclosure. The method 1400 as may be performed by a UE (e.g., 111-116 as illustrated in FIG. 1). An embodiment of the method 1400 shown in FIG. 14 is for illustration only. One or more of the components illustrated in FIG. 14 can be implemented in specialized circuitry configured to perform the noted functions or one or more of the components can be implemented by one or more processors executing instructions to perform the noted functions.

As illustrated in FIG. 14, the method 1400 begins at step 1402. In step 1402, a condition is triggered to send inter-UE co-ordination information. In step 1404, a request is sent to LTE SL module. In step 1406, an LTE SL module determines preferred and/or non-preferred resources. In step 1408, the LTE SL module sends resources to NR SL module. Finally, in step 1410, the preferred and/or non-preferred resources (from LTE and/or NR) is sent on NR SL interface.

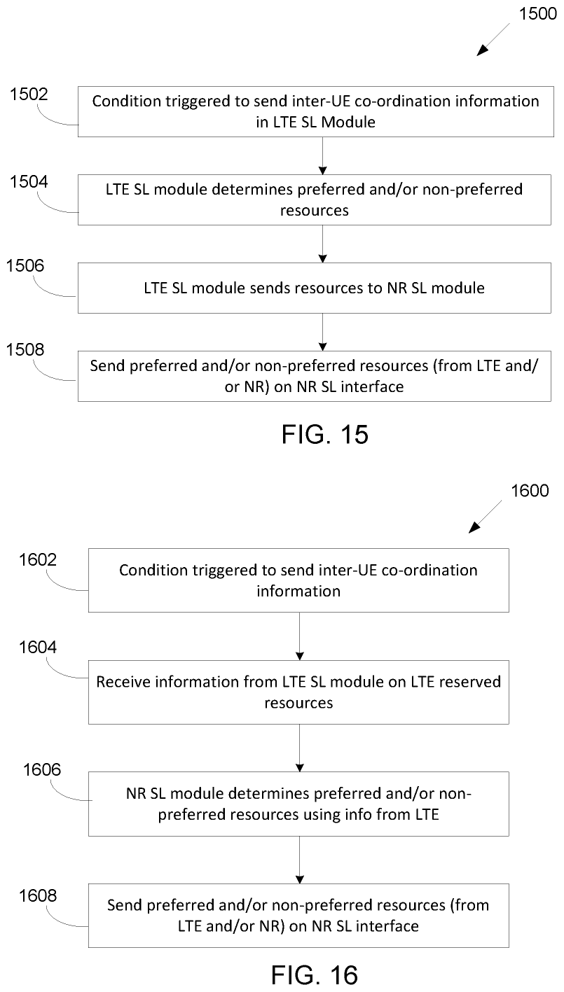

In one example, as illustrated in FIG. 14, the NR SL module determines based on a condition to send inter-UE co-ordination information to a second UE, the NR SL module sends a request to the LTE SL module for information to assist in determining preferred or non-preferred resources for inter-UE co-ordination (or the LTE SL module determines based on a condition to send inter-UE co-ordination information to a second UE as illustrated in FIG. 15).

FIG. 15 illustrates another flowchart of a method 1500 for sending an inter-UE co-ordination information according to embodiments of the present disclosure. The method 1500 as may be performed by a UE (e.g., 111-116 as illustrated in FIG. 1). An embodiment of the method 1500 shown in FIG. 15 is for illustration only. One or more of the components illustrated in FIG. 15 can be implemented in specialized circuitry configured to perform the noted functions or one or more of the components can be implemented by one or more processors executing instructions to perform the noted functions.

As illustrated in FIG. 15, the method 1500 begins at step 1502. In step 1502, a condition is triggered to send inter-UE co-ordination information in an LTE SL module. In step 1504, the LTE SL module determines preferred and/or non-preferred resources. In step 1506, the LTE SL module sends resources to NR SL module. Finally, in step 1508, the preferred and/or non-preferred resources (from LTE and/or NR) is sent on NR SL interface.

The request sent to the LTE SL module (e.g., in FIG. 14) can include information related to the inter-UE co-ordination information to be sent to the second UE (e.g., resource selection, etc.). The LTE SL module provides information to the NR SL module. Inter-UE co-ordination information is sent to the second UE using (e.g., based on) information provided by the LTE module.

In one example, the inter-UE co-ordination information includes preferred resources determined at least in part based on the information provided by the LTE module.

In one example, the inter-UE co-ordination information includes non-preferred resources determined at least in part based on the information provided by the LTE module.

In one example, the inter-UE co-ordination information includes preferred resources and non-preferred resources determined at least in part based on the information provided by the LTE module.

FIG. 16 illustrates yet another flowchart of a method 1600 for sending an inter-UE co-ordination information according to embodiments of the present disclosure. The method 1600 as may be performed by a UE (e.g., 111-116 as illustrated in FIG. 1). An embodiment of the method 1600 shown in FIG. 16 is for illustration only. One or more of the components illustrated in FIG. 16 can be implemented in specialized circuitry configured to perform the noted functions or one or more of the components can be implemented by one or more processors executing instructions to perform the noted functions.

As illustrated in FIG. 16, the method 1600 begins at step 1602. In step 1602, a condition is triggered to send inter-UE co-ordination information. In step 1604, the NR module receives information from an LTE SL module on LTE reserved resources. In step 1606, the NR SL module determines preferred and/or non-preferred resources using (e.g., based on) info from LTE. Finally, in step 1608, the preferred and/or non-preferred resources (from LTE and/or NR) is sent on NR SL interface.

In one example as illustrated in FIG. 16, the NR SL module determines based on a condition to send inter-UE co-ordination information to a second UE, the NR SL module sends inter-UE co-ordination information to the second UE using (e.g., based on) information provided by the LTE module.

In one example, the inter-UE co-ordination information includes preferred resources determined at least in part based on the information provided by the LTE module.

In one example, the inter-UE co-ordination information includes non-preferred resources determined at least in part based on the information provided by the LTE module.

In one example, the inter-UE co-ordination information includes preferred resources and non-preferred resources determined at least in part based on the information provided by the LTE module.

The present disclosure considers dynamic co-channel co-existence between LTE SL and NR SL. A UE consists of two modules (or entities), an LTE SL module (or entity) and an NR SL module (or entity). The modules exchange messages to enable the NR SL module to adapt the NR SL traffic based on existing LTE SL traffic. In this disclosure, the timing of procedures associated with LTE SL and NR SL co-channel co-existence is provided.

In the present disclosure, the timing of procedures associated with LTE SL and NR SL dynamic co-channel co-existence is provided.

This disclosure considers the timing of procedures associated with dynamic co-channel co-existence between LTE SL and NR SL.

In one example, the sensing result is provided from the LTE SL module to the NR SL module periodically, i.e., every time period Tₚₑᵣ.

In one example, Tₚₑᵣ is units of physical time (e.g., milli-seconds, subframes, physical slots).

In one example, Tₚₑᵣ is in units of logical slots that can be in a resource pool for an NR resource pool.

In one example, Tₚₑᵣ is in units of logical slots in a resource pool for an NR resource pool.

In one example, Tₚₑᵣ is in units of logical subframes in a resource pool for an LTE resource pool.

Tₚₑᵣ can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI). In one example, Tₚₑᵣ can be determined by the NR SL module and sent to the LTE SL module. In one example, Tₚₑᵣ can be determined by the LTE SL module.

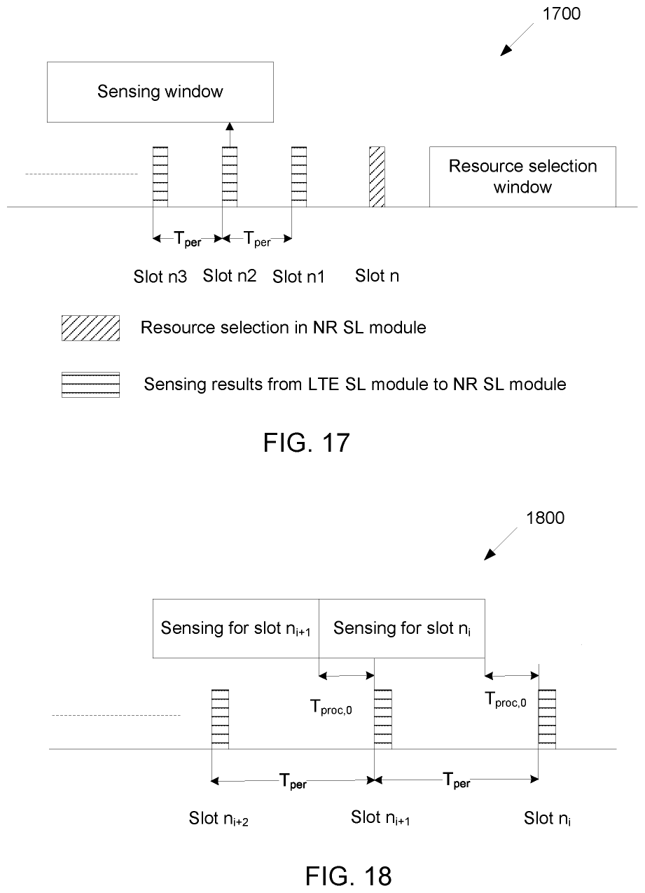

FIG. 17 illustrates an examples of LTE SL module to send sensing results 1700 according to embodiments of the present disclosure. An embodiment of the LTE SL module to send sensing results 1700 shown in FIG. 17 is for illustration only.

FIG. 17 illustrates an example, where the LTE SL module sends sensing results (sensing information) to the NR SL module periodically. For example, the sensing results is sent in slots n₁, n₂, n₃, . . . where n₁, n₂, n₃, are slots based on the NR SL numerology and n₁−n₂=Tₚₑᵣ, n₂31 n₃=Tₚₑᵣ . . . . In another example, the sensing results is sent in subframes m₁, m₂, m₃, . . . where m₁, m₂, m₃, are subframes based on the LTE SL numerology and m−m₂=Tₚₑᵣ, m₂−m₃=Tₚₑᵣ, . . .

FIG. 18 illustrates another examples of LTE SL module to send sensing results 1800 according to embodiments of the present disclosure. An embodiment of the LTE SL module to send sensing results 1800 shown in FIG. 18 is for illustration only.

In one example, in slot nᵢ or subframe mᵢ, the LTE SL module sends to NR SL module increment sensing results since the previous slot nᵢ₊₁ or subframe mᵢ₊₁ where sensing results was sent from the LTE SL module to the NR SL module, as illustrated in FIG. 18.

In one example, the sensing results sent from LTE SL module to NR SL module in slot nᵢ is the sensing results in the range [nᵢ₊₁−T_{proc,0}^{SL}, nᵢ−T_{proc,0}^{SL}) Wherein, T_{proc,0}^{SL} can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI). In one example, nᵢ, nᵢ₊₁ and T_{proc,0}^{SL} can be in units of physical time (e.g., physical slots), or logical slots that can be a resource pool or logical slots in a resource pool based on NR SL numerology. In one example, T_{proc,0}^{SL} is a sensing latency as described in 3GPP standard specification TS 38.214.

In one example, the sensing results sent from LTE SL module to NR SL module in slot nᵢ is the sensing results in the range (nᵢ₊₁−T_{proc,0}^{SL}, nᵢ−T_{proc,0}^{SL} . Wherein, T_{proc,0}^{SL} can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI). In one example, nᵢ, nᵢ₊₁ and T_{proc,0}^{SL} can be in units of physical time (e.g., physical slots), or logical slots that can be a resource pool or logical slots in a resource pool based on NR SL numerology. In one example, T_{proc,0}^{SL} is a sensing latency as described in 3GPP standard specification TS 38.214.

In one example, the sensing results sent from LTE SL module to NR SL module in subframe mᵢ is the sensing results in the range [mᵢ₊₁−T_{proc,0}^{SL}, mᵢ−T_{proc,0}^{SL}). Wherein, T_{proc,0}^{SL} can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI). In one example, mᵢ, mᵢ₊₁ and T_{proc,0}^{SL} can be in units of physical time (e.g., physical subframes), or logical subframes that can be a resource pool or logical subframes in a resource pool based on LTE SL numerology. In one example, T_{proc,0}^{SL} is a sensing latency as described in 3GPP standard specification TS 38.214, e.g., for 15 kHz.

In one example, the sensing results sent from LTE SL module to NR SL module in subframe mᵢ is the sensing results in the range (mᵢ₊₁−T_{proc,0}^{SL}, mᵢ−T_{proc,0}^{SL}]. Wherein, T_{proc,0}^{SL} can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI). In one example, mᵢ, mᵢ₊₁ and T_{proc,0}^{SL} can be in units of physical time (e.g., physical subframes), or logical subframes that can be a resource pool or logical subframes in a resource pool based on LTE SL numerology. In one example, T_{proc,0}^{SL} is a sensing latency as described in 3GPP standard specification TS 38.214, e.g., for 15 kHz.

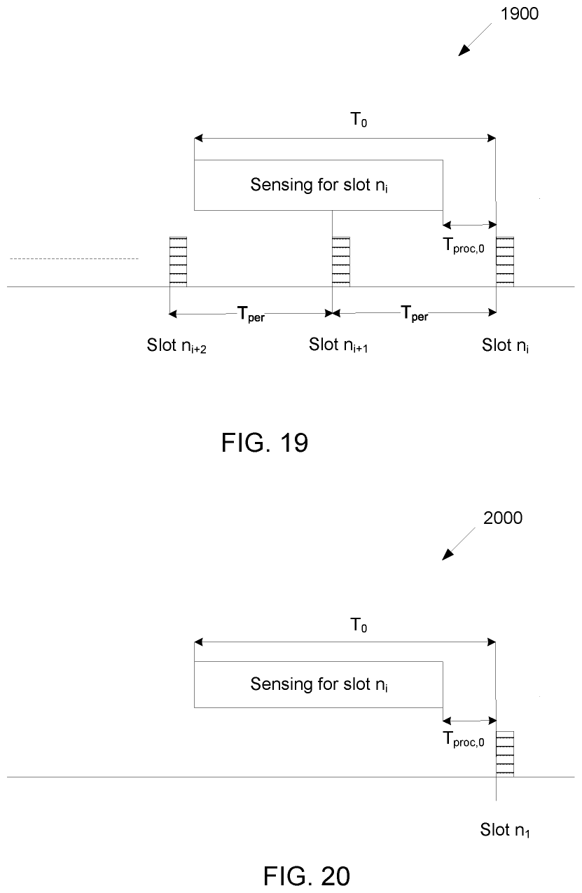

FIG. 19 illustrates yet another examples of LTE SL module to send sensing results 1900 according to embodiments of the present disclosure. An embodiment of the LTE SL module to send sensing results 1900 shown in FIG. 19 is for illustration only.

In one example, in slot nᵢ or subframe mᵢ, the LTE SL module sends to NR SL module sensing results in a sensing window starting before slot nᵢ₊₁ or subframe mᵢ₊₁, as illustrated in FIG. 19.

In one example, the sensing results sent from LTE SL module to NR SL module in slot nᵢ is the sensing results in the range [nᵢ−T₀, nᵢ−T_{proc,0}^{SL}) or [nᵢ−T₀, nᵢ−T_{proc,0}^{SL}0 or (nᵢ−T₀, nᵢ−T_{proc,0}^{SL}) or (nᵢ−T_{proc,0}^{SL}]. Wherein, T_{proc,0}^{SL} and/or T₀ can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI). In one example, nᵢ. T_{proc,0}^{SL} and T₀ can be in units of physical time (e.g., physical slots), or logical slots that can be a resource pool or logical slots in a resource pool based on NR SL numerology. In one example, T_{proc,0}^{SL} is a sensing latency as described in 3GPP standard specification TS 38.214.

In one example, the sensing results sent from LTE SL module to NR SL module in subframe mᵢ is the sensing results in the range [mᵢ−T₀, mᵢ−T_{proc,0}^{SL}) or [mᵢ−T₀, mᵢ−T_{proc,0}^{SL}] or (mᵢ−T₀, mᵢ−T_{proc,0}^{SL}) or (mᵢ−T₀, mᵢ−T_{proc,0}^{SL}]. Wherein T_{proc,0}^{SL} and/or T₀ can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI). In one example, mᵢ, T_{proc,0}^{SL} and T₀ can be in units of physical time (e.g., physical subframes), or logical subframes that can be a resource pool or logical subframes in a resource pool based on LTE SL numerology. In one example, T_{proc,0}^{SL} is a sensing latency as described in 3GPP standard specification TS 38.214, e.g., for 15 kHz.

FIG. 20 illustrates yet another examples of LTE SL module to send sensing results 2000 according to embodiments of the present disclosure. An embodiment of the LTE SL module to send sensing results 2000 shown in FIG. 20 is for illustration only.

In another example, sensing results (sensing information) is provided from the LTE module to the NR SL module when a condition is satisfied. In one example, the sensing results (sensing information) is provided in slot n₁ or subframe m₁ (e.g., one shot), as illustrated in FIG. 20.

In one example, the sensing results sent from LTE SL module to NR SL module in subframe n₁ is the sensing results in the range [n₁−T₀, n₁−T_{proc,0}^{SL}) or [n₁−T₀, n₁−T_{proc,0}^{SL}] or (n₁−T₀, n₁−T_{proc,0}^{SL}) or (n₁−T₀, n₁−T_{proc,0}^{SL}]. Wherein, T_{proc,0}^{SL} and/or T₀ can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI). In one example, n₁, nᵢ₊₁, T_{proc,0}^{SL} and T₀ can be in units of physical time (e.g., physical slots), or logical slots that can be a resource pool or logical slots in a resource pool based on NR SL numerology. In one example, T_{proc,0}^{SL} is a sensing latency as described in 3GPP standard specification TS 38.214.

In one example, the sensing results sent from LTE SL module to NR SL module in subframe mi is the sensing results in the range [mᵢ−T₀, mᵢ−T_{proc,0}^{SL}) or [mᵢ−T₀, mᵢ−T_{proc,0}^{SL}] (mᵢ−T₀, mᵢ−T_{proc,0}^{SL}) or (mᵢ−T₀, mᵢ−T_{proc,0}^{SL}]. Wherein T_{proc,0}^{SL} and/or T₀ can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI). In one example, mᵢ, mᵢ₊₁, T_{proc,0}^{SL}]. and T₀ can be in units of physical time (e.g., physical subframes), or logical subframes that can be a resource pool or logical subframes in a resource pool based on LTE SL numerology. In one example, T_{proc,0}^{SL} is a sensing latency as described in 3GPP standard specification TS 38.214, e.g., for 15 kHz.

In one example, sensing results (sensing information) is provided from the LTE module to the NR SL module when a condition is satisfied. In one example, the sensing results (sensing information) is provided in slot nᵢ or subframe mᵢ, wherein i=1, 2, . . . M. There are M instances of sensing results provided from LTE SL module to NR SL module. Wherein, M can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI).

In one example, nᵢ₊₁−nᵢ=Tₚₑᵣ. Wherein Tₚₑᵣ can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI). In one example, nᵢ, nᵢ₊₁ and Tₚₑᵣ can be in units of physical time (e.g., physical slots), or logical slots that can be a resource pool or logical slots in a resource pool based on NR SL numerology.

In one example, mᵢ₊₁−mᵢ=Tₚₑᵣ. Wherein Tₚₑᵣ can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI). In one example, mᵢ, mᵢ₊₁ and Tₚₑᵣ can be in units of physical time (e.g., physical sub-frames), or logical subframes that can be a resource pool or logical subframes in a resource pool based on LTE SL numerology, e.g., 15 kHz.

In one example, sensing results (sensing information) is provided from the LTE module to the NR SL module when a condition is satisfied. The sensing results continue to be provided periodic with a period Tₚₑᵣ as illustrated in FIG. 18 or FIG. 19 until the condition to send sensing results ceases to exist. Tₚₑᵣ can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI).

In one example, Tₚₑᵣ can be in units of physical time (e.g., physical slots), or logical slots that can be a resource pool or logical slots in a resource pool based on NR SL numerology.

In one example, Tₚₑᵣ can be in units of physical time (e.g., physical sub-frames), or logical subframes that can be a resource pool or logical subframes in a resource pool based on LTE SL numerology, e.g., 15 kHz.

The condition to trigger the sending the sensing results (sensing information) from the LTE SL module to the NR SL module can be one or more of: (1) CBR on the LTE SL interface exceeds a threshold. Wherein, the threshold can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI); (2) BLER averaged over N subframes for the LTE SL interface exceeds a threshold. Wherein, the threshold and N can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI); (3) RSSI averaged over N subframes for the LTE SL interface exceeds a threshold. Wherein, the threshold and N can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI); and (4) the condition can also be left to UE's implementation.

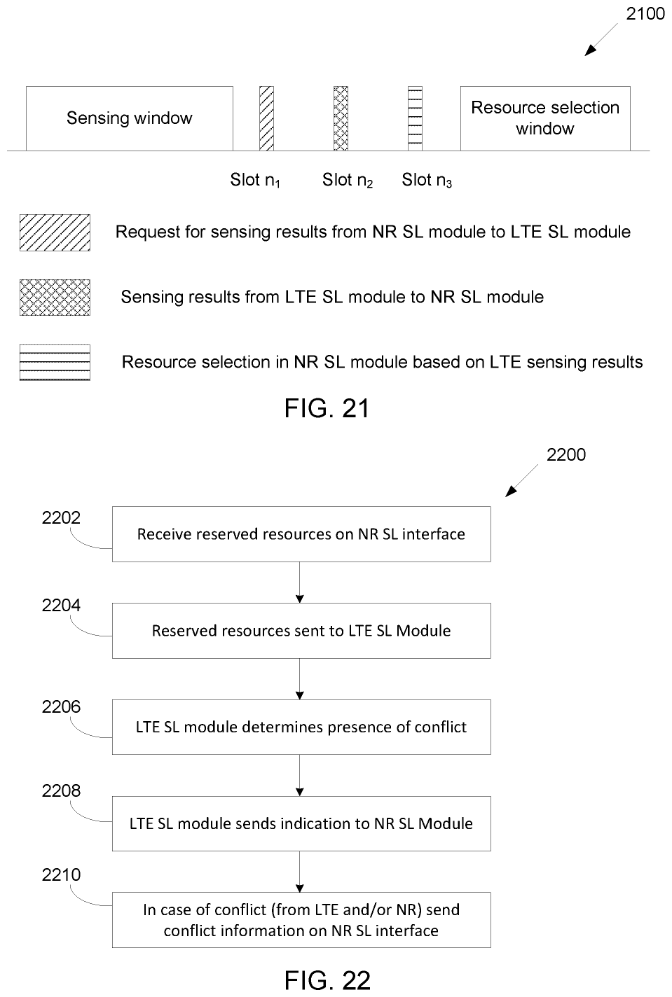

FIG. 21 illustrates yet another examples of LTE SL module to send sensing results 2100 according to embodiments of the present disclosure. An embodiment of the LTE SL module to send sensing results 2100 shown in FIG. 21 is for illustration only.

In one example, illustrated in FIG. 21, the NR SL module sends a request to the LTE SL module for LTE sensing information. The LTE SL module provides sensing results in response to the request.

In slot n₁, corresponding to sub-frame m₁, NR SL module sends a request to the LTE SL module for sensing information. Slot n₁ is based on the NR SL numerology. Slot m₁ is based on the LTE SL numerology. Slot n₁ can be a slot within sub-frame m₁ (e.g., the first slot with the sub-frame, the last slot within the sub-frame or any slot within the sub-frame).

In slot n₂, corresponding to sub-frame m₂, the LTE SL module sends sensing results to the NR SL module. Slot n₂ is based on the NR SL numerology. Slot m₂ is based on the LTE SL numerology. Slot n₂ can be a slot within sub-frame m₂ (e.g., the first slot with the sub-frame, the last slot within the sub-frame or any slot within the sub-frame).

In one example, the sensing results can be the sensing results within a sensing window [m₁−T_{0,} m₁−T_{proc,0}^{SL}). Wherein, T_{proc,0}^{SL} and/or T₀ can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI). In one example, m₁, T_{proc,0}^{SL} and T₀ can be in units of physical time (e.g., physical subframes), or logical subframes that can be a resource pool or logical subframes in a resource pool based on LTE SL numerology. In one example, T_{proc,0}^{SL} is a sensing latency as described in 3GPP standard specification TS 38.214, e.g., for 15 kHz.

In one example, the sensing results can be the sensing results within a sensing window [n₁−T₀, n₁−T_{proc,0}^{SL}). Wherein, T_{proc,0}^{SL} and/or T₀ can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI). In one example, n₁, T_{proc,0}^{SL} and T₀ can be in units of physical time (e.g., physical slots), or logical slots that can be a resource pool or logical slots in a resource pool based on NR SL numerology. In one example, T_{proc,0}^{SL} is a sensing latency as described in 3GPP standard specification TS 38.214.

In one example, the sensing results can be the sensing results within a sensing window [m₂−T₀, m₂−T_{proc,0}^{SL}). Wherein, T_{proc,0}^{SL} and/or T₀ can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI). In one example, m₂, T_{proc,0}^{SL} and T₀ can be in units of physical time (e.g., physical subframes), or logical subframes that can be a resource pool or logical subframes in a resource pool based on LTE SL numerology. In one example, T_{proc,0}^{SL} is a sensing latency as described in 3GPP standard specification TS 38.214, e.g., for 15 kHz.

In one example, the sensing results can be the sensing results within a sensing window [n₂−T₀, n₂−T_{proc,0}^{SL}). Wherein, T₀ and T_{proc,0}^{L} are in units of slots of the NR SL numerology. Wherein, T_{proc,0}^{SL} and/or T₀ can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI). In one example, n₂, T_{proc,0}^{SL} and T₀ can be in units of physical time (e.g., physical slots), or logical slots that can be a resource pool or logical slots in a resource pool based on NR SL numerology. In one example, T_{proc,0}^{SL} is a sensing latency as described in 3GPP standard specification TS 38.214.

In one example, the LTE-based sensing results can be the sensing results within a sensing window [m₃−T₀, m₃−T_{proc,0}^{SL}). m₃ the sub-frame the NR SL module determines the candidate resources (i.e., resource selection) within a resource selection window. Wherein, T_{proc,0}^{SL} and/or T₀ can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI). In one example, m₃, T_{proc,0}^{SL} and T₀ can be in units of physical time (e.g., physical subframes), or logical subframes that can be a resource pool or logical subframes in a resource pool based on LTE SL numerology. In one example, T_{proc,0}^{SL} is a sensing latency as described in 3GPP standard specification TS 38.214, e.g., for 15 kHz.

In one example, the sensing results can be the sensing results within a sensing window [n₃−T₀, n₃−T_{proc,0}^{SL}). Wherein, T₀ and T_{proc,0}^{SL} are in units of slots of the NR SL numerology. n₃ the slot, based on the NR SL numerology, the NR SL module determines the candidate resources (i.e., resource selection) within a resource selection window. Wherein, T_{proc,0}^{SL} and/or T₀ can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI). In one example, n₃, T_{proc,0}^{SL} and T₀ can be in units of physical time (e.g., physical slots), or logical slots that can be a resource pool or logical slots in a resource pool based on NR SL numerology. In one example, T_{proc,0}^{SL} is a sensing latency as described in 3GPP standard specification TS 38.214.

In one example, the sensing results can be the sensing results within a sensing window [m₃−T₀, m₂−T_{proc,0}^{SL}). m₃ the sub-frame the NR SL module determines the candidate resources within a resource selection window. Wherein, T_{proc,0}^{SL} and/or T₀ can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI). In one example, m₂, m₃, T_{proc,0}^{SL} and T₀ can be in units of physical time (e.g., physical subframes), or logical subframes that can be a resource pool or logical subframes in a resource pool based on NR SL numerology. In one example, T_{proc,0}^{SL} is a sensing latency as described in 3GPP standard specification TS 38.214, e.g., 15 kHz.

In one example, the sensing results can be the sensing results within a sensing window [n₃−T₀,n₂−T_{proc,0}^{SL}). n₃ the slot, based on the NR SL numerology, the NR SL module determines the candidate resources within a resource selection window. Wherein, T_{proc,0}^{SL} and/or T₀ can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI). In one example, n₂, n₃, T_{proc,0}^{SL} and T₀ can be in units of physical time (e.g., physical slots), or logical slots that can be a resource pool or logical slots in a resource pool based on NR SL numerology. In one example, T_{proc,0}^{SL} is a sensing latency as described in 3GPP standard specification TS 38.214.

In one example, m₂=m₁. m₁ and m₂ can be in units of physical time (e.g., physical subframes), or logical subframes that can be a resource pool or logical subframes in a resource pool.

In one example, m₂=m₁+1. m₁ and m₂ can be in units of physical time (e.g., physical subframes), or logical subframes that can be a resource pool or logical subframes in a resource pool.

In one example, m₂=m₁+T. Wherein, T can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI). m₁, m₂ and T can be in units of physical time (e.g., physical subframes), or logical subframes that can be a resource pool or logical subframes in a resource pool. In one example, T is up to the UE's implementation.

In one example, n₂=n₁. n₁ and n₂ can be in units of physical time (e.g., physical slots), or logical slots that can be a resource pool or logical slots in a resource pool.

In one example, n₂=n₁+1. n₁ and n₂ can be in units of physical time (e.g., physical slots), or logical slots that can be a resource pool or logical slots in a resource pool.

In one example, n₂=n₁+T. Wherein, T can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI). n₁, n₂ and T can be in units of physical time (e.g., physical slots), or logical slots that can be a resource pool or logical slots in a resource pool. In one example, T is up to the UE's implementation.

In slot n₃, corresponding to sub-frame m₃, NR SL module determines the candidate resources (i.e., resource selection) within a resource selection window based on the sensing results received from the LTE module and its own sensing results (NR sensing results). As aforementioned, for resource selection within slot n₃, the resource (re-)selection window is [n₃+T₁, n₃+T₂].

In one examples, the LTE-based sensing results can be the sensing results received from the LTE SL module.

In one example, the LTE-based sensing results can be the sensing results within a sensing window [m₃−T₀, m₃−T_{proc,0}^{SL}). Wherein, T₀ and T_{proc,0}^{SL} are in units of subframes.

In one example, the sensing results can be the sensing results within a sensing window [n₃−T₀, n₃−T_{proc,0}^{SL}). Wherein, T₀ and T_{proc,0}^{SL} are in units of slots of the NR SL numerology.

In one example, the sensing results can be the sensing results within a sensing window [m₃−T₀, m₂−T_{proc,0}^{SL}). Wherein, T₀ and T_{proc,0}^{SL} are in units of subframes.

In one example, the sensing results can be the sensing results within a sensing window [n₃−T₀, n₂−T_{proc,0}^{SL}). Wherein, T₀ and T_{proc,0}^{SL} are in units of slots of the NR SL numerology.

In one example, m₃=m₂. m₂ and m₃ can be in units of physical time (e.g., physical subframes), or logical subframes that can be a resource pool or logical subframes in a resource pool.

In one example, m₃=m₂+1. m₂ and m₃ can be in units of physical time (e.g., physical subframes), or logical subframes that can be a resource pool or logical subframes in a resource pool.

In one example, m₃=m₂+T. Wherein, T can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI). m₂, m₃ and T can be in units of physical time (e.g., physical subframes), or logical subframes that can be a resource pool or logical subframes in a resource pool. In one example, T is up to the UE's implementation.

In one example, n₃=n₂. n₂ and n₃ can be in units of physical time (e.g., physical slots), or logical slots that can be a resource pool or logical slots in a resource pool.

In one example, n₃=n₂+1. n₂ and n₃ can be in units of physical time (e.g., physical slots), or logical slots that can be a resource pool or logical slots in a resource pool.

In one example, n₃=n₂+T. Wherein, T can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI). n₂, n₃ and T can be in units of physical time (e.g., physical slots), or logical slots that can be a resource pool or logical slots in a resource pool. In one example, T is up to the UE's implementation.

The condition to trigger the sensing the request for sensing results (sensing information) from the NR SL module to the LTE SL module can be one or more of: (1) SL data is available to transmitted over the NR SL interface; (2) CBR on the NR SL interface exceeds a threshold. Wherein, the threshold can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI); (3) BLER averaged over N subframes for the NR SL interface exceeds a threshold. Wherein, the threshold and N can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI), in one example, N is up to the UE's implementation.; (4) RSSI averaged over N subframes for the NR SL interface exceeds a threshold. Wherein, the threshold and N can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI), in one example, N is up to the UE's implementation.; and (5) the condition can also be left to UE's implementation.

The response to the request for sensing results (sensing information) from the NR SL module to the LTE SL module can be one of the following examples.

In one example, the LTE SL module sends the sensing results as a one shot sensing result.

In one example, the LTE SL module sends the sensing results in M instances of sensing results provided. Wherein, M can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI), in one example, M is up to the UE's implementation. The time between any two instances of sensing results can be Tₚₑᵣ. Wherein Tₚₑᵣ can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI).

In one such example, nᵢ, nᵢ₊₁ and Tₚₑᵣ can be in units of physical time (e.g., physical slots), or logical slots that can be a resource pool or logical slots in a resource pool based on NR SL numerology.

In one such example, mᵢ, mᵢ₊₁ and Tₚₑᵣ can be in units of physical time (e.g., physical sub-frames), or logical subframes that can be a resource pool or logical subframes in a resource pool based on LTE SL numerology, e.g., 15 kHz.

In one example, after a trigger is sent from the NR SL module to the LTE SL module to sensing results, sensing results (sensing information) is provided from the LTE module to the NR SL module. The sensing results continue to be provided periodic with a period Tₚₑᵣ as illustrated in FIG. 18 or FIG. 19 until a new trigger is sent from the NR SL module to the LTE SL module to stop the sending of sensing results. Tₚₑᵣ can be specified in the system specifications and/or pre-configured and/or configured updated by Uu RRC and/or PC5 RRC and/or Uu MAC CE and/or PC5 MAC CE and/or Uu L1 control (DCI) and/or PC5 L1 control (SCI).

In one such example, Tₚₑᵣ can be in units of physical time (e.g., physical slots), or logical slots that can be a resource pool or logical slots in a resource pool based on NR SL numerology.

In one such example, Tₚₑᵣ can be in units of physical time (e.g., physical sub-frames), or logical subframes that can be a resource pool or logical subframes in a resource pool based on LTE SL numerology, e.g., 15 kHz.

The LTE SL module can provide the NR SL module one or more of following information: (1) LTE-related sensing information and (2) LTE SL transmission information.

In one example, when NR SL module receives information from the LTE SL module, the NR SL module uses the information for resource exclusion for the identification of candidate SL resources for SL resource (re-)selection.

In one example, when NR SL module receives information from the LTE SL module, the NR SL module uses the information for determination if a reserved SL resource indicated by a second UE has a conflict and if it has a conflict, a confliction indication is transmitted to the second UE.

FIG. 22 illustrates a flowchart of a method 2200 for receiving reserved resources according to embodiments of the present disclosure. The method 2200 as may be performed by a UE (e.g., 111-116 as illustrated in FIG. 1). An embodiment of the method 2200 shown in FIG. 22 is for illustration only. One or more of the components illustrated in FIG. 22 can be implemented in specialized circuitry configured to perform the noted functions or one or more of the components can be implemented by one or more processors executing instructions to perform the noted functions.

As illustrated in FIG. 22, the method 2200 begins at step 2202. In step 2202, the UE receives reserved resources on NR SL interface. In step 2204, the reserved resources is sent to an LTE SL module. In step 2206, the LTE SL module determines presence of conflict. In step 2208, the LTE SL module sends an indication to the NR SL module. Finally, in step 2210, in case of conflict (from LTE and/or NR), conflict information is sent on NR SL interface.

In one example, as illustrated in FIG. 22, the NR SL module receives reserved resources from a second UE. The NR SL module provides the reserved resources to the LTE SL module, the LTE SL module can determine whether the reserved resource has a conflict or not. The conflict status of the reserved resource is indicated to the NR SL module. In one example, if the resource is in conflict, the LTE SL module sends an indication to the NR SL module, otherwise no indication is sent. In one example, if the resource is not in conflict, the LTE SL module sends an indication to the NR SL module, otherwise no indication is sent. In one example, if the resource is in conflict, the LTE SL module sends an indication to the NR SL module that the resources is in conflict, otherwise if the resource is not in conflict, the LTE SL module sends an indication to the NR SL module that the resource is not in conflict.

A conflict can occur if the reserved resource overlaps in time and frequency with a reserved LTE SL resource of another UE.

A conflict can occur if the reserved resource overlaps in time with an LTE SL transmission from the LTE SL module.

In one example, the occurrence of a conflict can be based on the priority of the reserved resource and the priority of the LTE SL reserved resource.

In one example, the occurrence of a conflict can be based on SL RSRP associated with the reserved resource compared to a threshold wherein the threshold can depend the priority of the reserved resource and/or the priority of the LTE SL reserved resource.

If the resource is indicated (explicitly or implicitly) as in conflict with an LTE SL transmission, a conflict indication is sent to the second UE. In one example, the reserved resource for which a conflict is indicated is the next in time reserved resource.

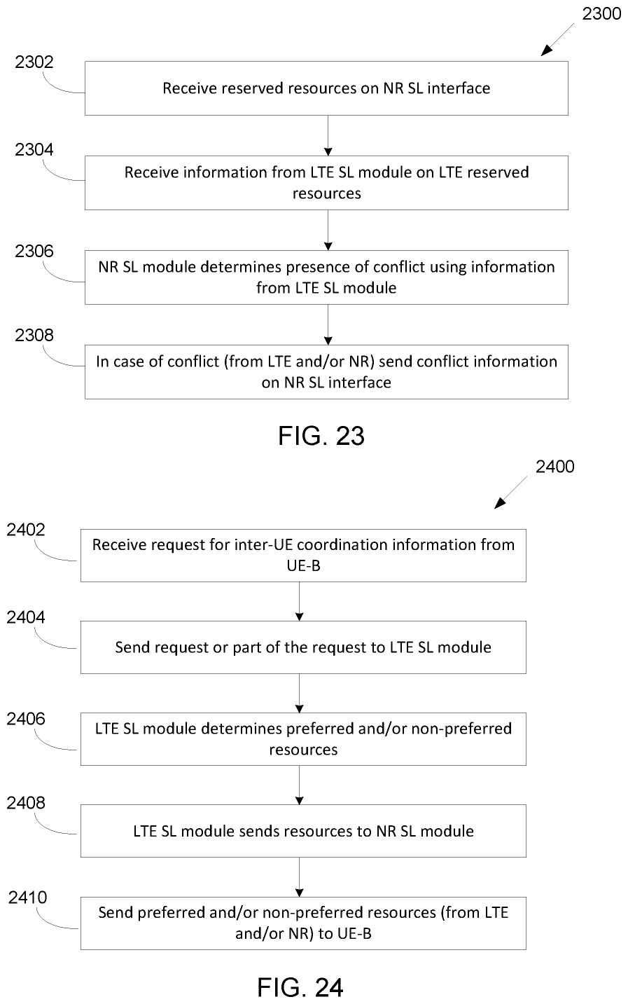

FIG. 23 illustrates another flowchart of a method 2300 for receiving reserved resources according to embodiments of the present disclosure. The method 2300 as may be performed by a UE (e.g., 111-116 as illustrated in FIG. 1). An embodiment of the method 2300 shown in FIG. 23 is for illustration only. One or more of the components illustrated in FIG. 23 can be implemented in specialized circuitry configured to perform the noted functions or one or more of the components can be implemented by one or more processors executing instructions to perform the noted functions.

As illustrated in FIG. 23, the method 2300 begins at step 2302. In step 2302, the UE receives reserved resources on NR SL interface. In step 2304, the UE receive information from an LTE SL module on LTE reserved resources. In step 2306, an NR SL module determines presence of conflict using (e.g., based on) information from LTE SL module. Finally, in step 2308, in case of conflict (from LTE and/or NR), conflict information is sent on NR SL interface.

In one example, as illustrated in FIG. 23, the NR SL module receives reserved resources from a second UE. The NR SL module determines based on information provided by the LTE SL module whether the reserved resource is in conflict or not.

A conflict can occur if the reserved resource overlaps in time and frequency with a resource indicated by the LTE module as being unavailable.

A conflict can occur if the reserved resource overlaps in time with an LTE SL transmission from the LTE SL module.

In one example, the occurrence of a conflict can be based on the priority of the reserved resource and the priority of the LTE SL reserved resource.

In one example, the occurrence of a conflict can be based on SL RSRP associated with the reserved resource compared to a threshold wherein the threshold can depend the priority of the reserved resource and/or the priority of the LTE SL reserved resource.

If the reserved resource of the second UE is in conflict with an LTE SL transmission, a conflict indication is sent to the second UE. In one example, the reserved resource for which a conflict is indicated is the next in time reserved resource.

In one example, when NR SL module receives information from the LTE SL module, the NR SL module uses the information for determination of preferred and/or non-preferred resources to send to one or more second UEs.

FIG. 24 illustrates a flowchart of a method 2400 for receiving an inter-UE co-ordination request according to embodiments of the present disclosure. The method 2400 as may be performed by a UE (e.g., 111-116 as illustrated in FIG. 1). An embodiment of the method 2400 shown in FIG. 24 is for illustration only. One or more of the components illustrated in FIG. 24 can be implemented in specialized circuitry configured to perform the noted functions or one or more of the components can be implemented by one or more processors executing instructions to perform the noted functions.

As illustrated in FIG. 24, the method 2400 begins at step 2402. In step 2402, the UE receives a request for inter-UE coordination information from a UE-B (i.e., a second UE). In step 2404, the request or part of the request is sent to an LTE SL module. In step 2406, an LTE SL module determines preferred and/or non-preferred resources. In step 2408, the LTE SL module sends resources to an NR SL module. Finally, in step 2410, the preferred and/or non-preferred resources (from LTE and/or NR) is sent to a UE-B.

In one example, as illustrated in FIG. 24, the NR SL module receives an inter-UE co-ordination request from a second UE. In response to the inter-UE co-ordination request, the NR SL module sends a request to the LTE SL module for information to assist in determining preferred or non-preferred resources for inter-UE co-ordination. The request sent to the LTE SL module can include information provided by the second UE in the inter-UE co-ordination request. The LTE SL module provides information to the NR SL module. Inter-UE co-ordination information is sent to the second UE using (e.g. based on) information provided by the LTE module.

In one example, the inter-UE co-ordination information includes preferred resources determined at least in part based on the information provided by the LTE module.

In one example, the inter-UE co-ordination information includes non-preferred resources determined at least in part based on the information provided by the LTE module.

In one example, the inter-UE co-ordination information includes preferred resources and non-preferred resources determined at least in part based on the information provided by the LTE module.

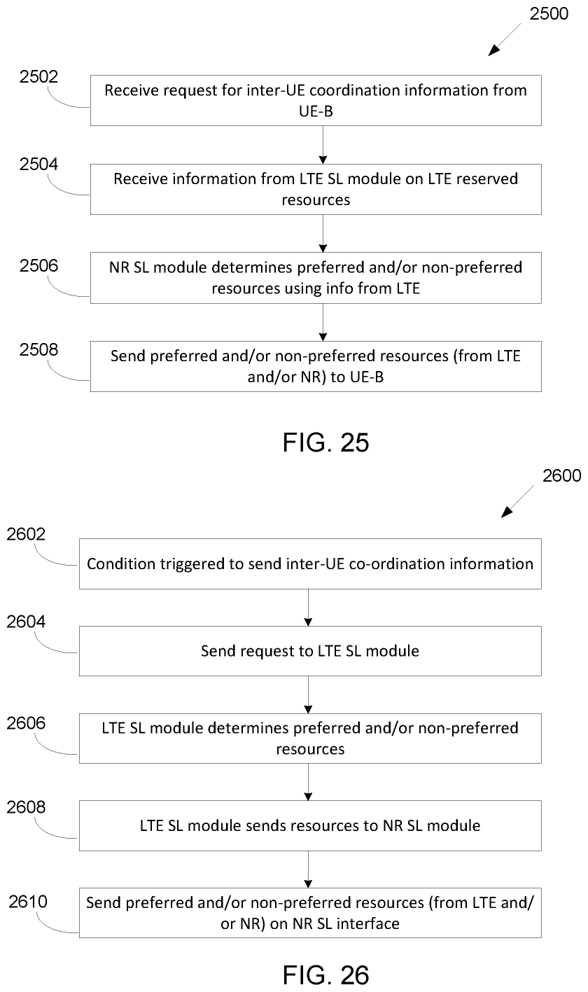

FIG. 25 illustrates a flowchart of a method 2500 for receiving an inter-UE co-ordination request according to embodiments of the present disclosure. The method 2500 as may be performed by a UE (e.g., 111-116 as illustrated in FIG. 1). An embodiment of the method 2500 shown in FIG. 25 is for illustration only. One or more of the components illustrated in FIG. 25 can be implemented in specialized circuitry configured to perform the noted functions or one or more of the components can be implemented by one or more processors executing instructions to perform the noted functions.

As illustrated in FIG. 25, the method 2500 begins at step 2502. In step 2502, the UE receives a request for inter-UE coordination information from a UE-B. In step 2504, the NR module receives information from an LTE SL module on LTE reserved resources. In step 2506, the NR SL module determines preferred and/or non-preferred resources using (e.g., based on) info from LTE. Finally, in step 2508, the preferred and/or non-preferred resources (from LTE and/or NR) is sent to a UE-B.

In one example, as illustrated in FIG. 25, the NR SL module receives an inter-UE co-ordination request from a second UE. In response to the inter-UE co-ordination request, the NR SL module sends inter-UE co-ordination information to the second UE using (e.g., based on) information provided by the LTE module.

In one example, the inter-UE co-ordination information includes preferred resources determined at least in part based on the information provided by the LTE module.

In one example, the inter-UE co-ordination information includes non-preferred resources determined at least in part based on the information provided by the LTE module.

In one example, the inter-UE co-ordination information includes preferred resources and non-preferred resources determined at least in part based on the information provided by the LTE module.

FIG. 26 illustrates a flowchart of a method 2600 for sending an inter-UE co-ordination information according to embodiments of the present disclosure. The method 2600 as may be performed by a UE (e.g., 111-116 as illustrated in FIG. 1). An embodiment of the method 2600 shown in FIG. 26 is for illustration only. One or more of the components illustrated in FIG. 26 can be implemented in specialized circuitry configured to perform the noted functions or one or more of the components can be implemented by one or more processors executing instructions to perform the noted functions.

As illustrated in FIG. 26, the method 2600 begins at step 2602. In step 2602, a condition is triggered to send inter-UE co-ordination information. In step 2604, a request is sent to an LTE SL module. In step 2606, an LTE SL module determines preferred and/or non-preferred resources. In step 2608, the LTE SL module sends resources to an NR SL module. Finally, in step 2610, the preferred and/or non-preferred resources (from LTE and/or NR) is sent on NR SL interface.

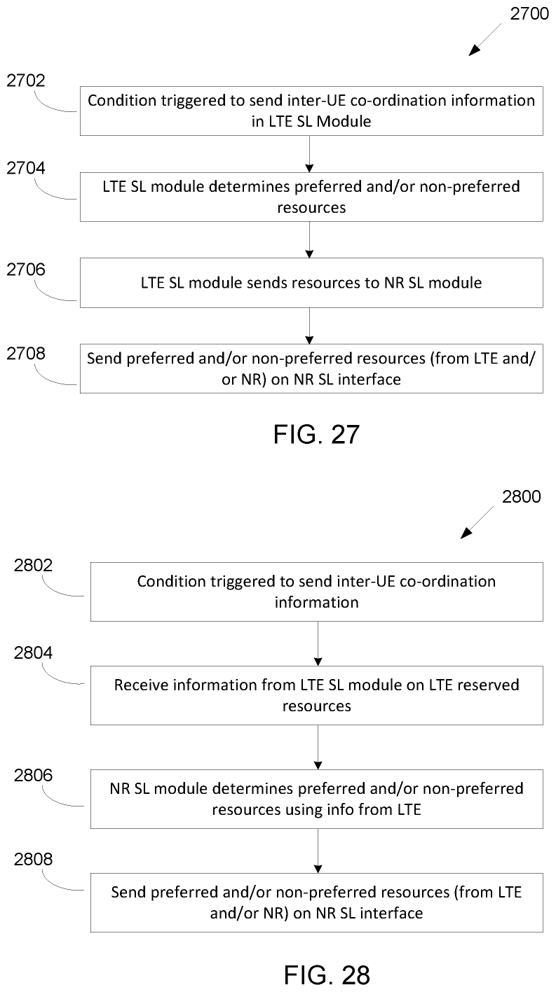

In one example, as illustrated in FIG. 26, the NR SL module determines based on a condition to send inter-UE co-ordination information to a second UE, the NR SL module sends a request to the LTE SL module for information to assist in determining preferred or non-preferred resources for inter-UE co-ordination (or the LTE SL module determines based on a condition to send inter-UE co-ordination information to a second UE as illustrated in FIG. 27).

FIG. 27 illustrates another flowchart of a method 2700 for sending an inter-UE co-ordination information according to embodiments of the present disclosure. The method 2700 as may be performed by a UE (e.g., 111-116 as illustrated in FIG. 1). An embodiment of the method 2700 shown in FIG. 27 is for illustration only. One or more of the components illustrated in FIG. 27 can be implemented in specialized circuitry configured to perform the noted functions or one or more of the components can be implemented by one or more processors executing instructions to perform the noted functions.

As illustrated in FIG. 27, the method 2700 begins at step 2702. In step 2702, a condition is triggered to send inter-UE co-ordination information in an LTE SL module. In step 2704, the LTE SL module determines preferred and/or non-preferred resources. In step 2706, the LTE SL module sends resources to an NR SL module. Finally, in step 2708, the preferred and/or non-preferred resources (from LTE and/or NR) is sent on NR SL interface.

The request sent to the LTE SL module (e.g., in FIG. 26) can include information related to the inter-UE co-ordination information to be sent to the second UE (e.g., resource selection, etc.). The LTE SL module provides information to the NR SL module. Inter-UE co-ordination information is sent to the second UE using (e.g. based on) information provided by the LTE module.

In one example, the inter-UE co-ordination information includes preferred resources determined at least in part based on the information provided by the LTE module.

In one example, the inter-UE co-ordination information includes non-preferred resources determined at least in part based on the information provided by the LTE module.

In one example, the inter-UE co-ordination information includes preferred resources and non-preferred resources determined at least in part based on the information provided by the LTE module.

FIG. 28 illustrates yet another flowchart of a method 2800 for sending an inter-UE co-ordination information according to embodiments of the present disclosure. The method 2800 as may be performed by a UE (e.g., 111-116 as illustrated in FIG. 1). An embodiment of the method 2800 shown in FIG. 28 is for illustration only. One or more of the components illustrated in FIG. 28 can be implemented in specialized circuitry configured to perform the noted functions or one or more of the components can be implemented by one or more processors executing instructions to perform the noted functions.

As illustrated in FIG. 28, the method 2800 begins at step 2802. In step 2802, a condition is triggered to send inter-UE co-ordination information. In step 2804, the NR module receives information from an LTE SL module on LTE reserved resources. In step 2806, the NR SL module determines preferred and/or non-preferred resources using (e.g. based on) info from LTE. Finally, in step 2808, the preferred and/or non-preferred resources (from LTE and/or NR) is sent on NR SL interface.

In one example as illustrated in FIG. 28, the NR SL module determines based on a condition to send inter-UE co-ordination information to a second UE, the NR SL module sends inter-UE co-ordination information to the second UE using (e.g. based on) information provided by the LTE module.

In one example, the inter-UE co-ordination information includes preferred resources determined at least in part based on the information provided by the LTE module.

In one example, the inter-UE co-ordination information includes non-preferred resources determined at least in part based on the information provided by the LTE module.

In one example, the inter-UE co-ordination information includes preferred resources and non-preferred resources determined at least in part based on the information provided by the LTE module.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver; and
a processor operably coupled to the transceiver, the processor configured to:
perform, via a long term evolution (LTE) sidelink (SL) entity, sensing over a LTE SL interface including to decode SL control information (SCI) and measure a SL reference signal receive power (SL-RSRP) associated with the SCI,
select resources for a LTE SL transmission by the LTE SL entity,
identify, for a new radio (NR) SL entity, information related to the sensing and the selected resources, and
perform, for the NR SL entity, a NR SL resource selection or reselection based on the information related to the sensing and the selected resources.

2. The UE of claim 1, wherein the information related to the sensing includes a time and frequency location of resources determined based on the decoded SCI.

3. The UE of claim 1, wherein the information related to the sensing includes a periodicity determined based on the decoded SCI.

4. The UE of claim 1, wherein the information related to the sensing includes a priority determined based on the decoded SCI.

5. The UE of claim 1, wherein the information related to the sensing includes the SL RSRP associated with the decoded SCI.

6. The UE of claim 1, wherein the information related to the resources selected for the LTE SL transmission includes:
time and frequency resources of the selected resources,
a periodicity of the LTE SL transmission, and
a priority of the LTE SL transmission.

7. The UE of claim 1, wherein the NR SL entity triggers the LTE SL entity to provide the information.

8. The UE of claim 1, wherein the LTE SL entity is configured to provide the information periodically to the NR SL entity.

9. The UE of claim 1, wherein:
the transceiver is configured to receive, via a radio interface for the NR SL entity, an indication of a reserved resource from a second UE,
the processor is further configured to determine whether a conflict exists for the reserved resource based on the information, and
the transceiver is further configured to, if the conflict exists, transmit, via the radio interface for the NR SL entity, a conflict indication.

10. The UE of claim 1, wherein:
the processor is further configured to identify preferred or non-preferred resources for a second UE based on the information, and
the transceiver is further configured to transmit, via a radio interface for the NR SL entity, information indicating the preferred or non-preferred resources.

11. A method of operating a user equipment (UE), the method comprising:
performing, via a long term evolution (LTE) sidelink (SL) entity, sensing over a LTE SL interface including to decode SL control information (SCI) and measure a SL reference signal receive power (SL-RSRP);
selecting resources for a LTE SL transmission by the LTE SL entity;
identifying, for a new radio (NR) SL entity, information related to the sensing and the selected resources; and
performing, for the NR SL entity, a NR SL resource selection or reselection based on the information related to the sensing and the selected resources.

12. The method of claim 11, wherein the information related to the sensing includes a time and frequency location of resources determined based on the decoded SCI.

13. The method of claim 11, wherein the information related to the sensing includes a periodicity determined based on the decoded SCI.

14. The method of claim 11, wherein the information related to the sensing includes a priority determined based on the decoded SCI.

15. The method of claim 11, wherein the information related to the sensing includes the SL RSRP associated with the decoded SCI.

16. The method of claim 11, wherein the information related to the resources selected for the LTE SL transmission includes:
time and frequency resources of the selected resources,
a periodicity of the LTE SL transmission, and
a priority of the LTE SL transmission.

17. The method of claim 11, further comprising triggering, via the NR SL entity, the LTE SL entity to provide the information.

18. The method of claim 11, further comprising providing, via the LTE SL entity, the information periodically to the NR SL entity.

19. The method of claim 11, further comprising:
receiving, via a radio interface for the NR SL entity, an indication of a reserved resource from a second UE,
determining whether a conflict exists for the reserved resource based on the information, and
based on determining that the conflict exists, transmitting, via the radio interface for the NR SL entity, a conflict indication. and

20. The method of claim 11, further comprising:
identifying preferred or non-preferred resources for a second UE based on the information, and
transmitting, via a radio interface for the NR SL entity, information indicating the preferred or non-preferred resources.
